(19) United States
(12) Patent Application Publication
(10) Pub. No.: US 2019/0389780 A1
(43) Pub. Date: Dec. 26, 2019

(54) SANITARY WARE AND METHOD OF MANUFACTURING SANITARY WARE

(71) Applicant: LIXIL Corporation, Tokyo (JP)

(72) Inventors: Toshinori MORI, Tokyo (JP); Kazuo TAKEUCHI, Tokyo (JP); Shunzou IWASAKI, Tokyo (JP); Isao YOSHINAGA, Tokyo (JP); Hiroyuki MIYAMOTO, Tokyo (JP); Tadashi ASHIZAWA, Tokyo (JP); Hideaki SAWADA, Tokyo (JP); Jaehoon CHOI, Tokyo (JP); Shuji KAWAI, Tokyo (JP)

(73) Assignee: LIXIL Corporation, Tokyo (JP)

(21) Appl. No.: 16/443,588

(22) Filed: Jun. 17, 2019

(30) Foreign Application Priority Data
Jun. 20, 2018 (JP) 2018-117446
Jun. 20, 2018 (JP) 2018-117447

(51) Int. Cl. C04B 41/50; C04B 41/00; C04B 41/86

(52) U.S. Cl. CPC C04B 41/5022; C04B 41/86; C04B 41/009

(57) ABSTRACT

Sanitary ware, including a ceramic base material, an upper glaze layer positioned on a surface of the ceramic base material, and an intermediate layer positioned between the ceramic base material and the upper glaze layer, wherein the sanitary ware satisfies at least one of the following conditions: a pore area ratio of 3% or less in terms of a ratio of an area of pores present in a cut surface obtained by cutting the upper glaze layer along the thickness direction thereof, relative to an area of the cut surface, an average pore size of 50 μm or less as measured with respect to the cut surface obtained by cutting the upper glaze layer along the thickness direction thereof, and a difference of 50 μm or less between the maximum and minimum values of the thickness of the upper glaze layer.

### CROSS REFERENCE TO RELATED APPLICATIONS

This application claims the priority of Japanese Application Nos. 2018-117446 and 2018-117447, each filed Jun. 20, 2018, the entire contents of which are hereby incorporated by reference.

### FIELD OF THE INVENTION

The present disclosure relates to sanitary ware and a method of manufacturing sanitary ware.

### BACKGROUND OF THE INVENTION

Conventionally, in sanitary ware such as a toilet bowl and a washbowl, an upper glaze layer (a glaze layer) is formed on an outermost surface thereof in order to inhibit adhesion of dirt or to improve the design characteristics of the appearance.

In recent years, there has been a need to seek not only hygiene but also a sense of luxury and quality in toilet and washroom spaces where sanitary ware is installed. Quality is not sensed only from design characteristics such as a color and a shape and can be sensed from parts other than these. One of the indicators indicating quality is image clarity. The image clarity is a characteristic that expresses the sharpness of an image reflected in a surface of sanitary ware, and the image clarity is determined to be higher as the reflected image becomes clearer. Sanitary ware with high image clarity gives an impression of high quality. In addition, one of the indicators representing quality is the “beauty” of sanitary ware. The term “beauty” relates to a general aesthetic feeling that can be sensed from brilliance, a tone of color, and the transparency of sanitary ware. Sanitary ware in which “beauty” is perceived gives an impression of high quality. For example, Japanese Patent Laid-Open No. 2012-72609 proposes sanitary ware in which a glaze layer having improved image clarity is formed on a surface of a ceramic base material. Japanese Patent Laid-Open No. 2005-298250 proposes sanitary ware in which a first colored glaze layer is formed on a surface of a ceramic base material and a second transparent glaze layer is formed thereon. In the sanitary ware disclosed in Japanese Patent Laid-Open No. 2005-298250, improvement of surface smoothness and improvement of thermal shock resistance are achieved.

“Depth” can be exemplified as an indicator indicating quality. The term “depth” relates to an expression of a thickness-directional deepness of an upper glaze layer on a surface of sanitary ware, and is recognized visually. Sanitary ware in which “depth” is perceived gives an impression of high quality. However, in the disclosure of Japanese Patent Laid-Open No. 2012-72609, the “depth” of sanitary ware was not taken into consideration. In the sanitary ware of Japanese Patent Laid-Open No. 2005-298250, the “beauty” of sanitary ware is not yet satisfactory.

### SUMMARY OF THE INVENTION

An object of this disclosure is to provide a sanitary ware which is capable of further improving at least one of the “depth” and the “beauty”.

In general, sanitary ware with high image clarity has a clear image reflected on a surface of the sanitary ware and tends to give an impression of high quality. However, as a result of intensive studies by the present disclosing party, even in the case of sanitary ware having high image clarity, a thickness-directional deepness was not necessarily sensed, and a correlation with “depth” or “beauty” was not able to be found. The present disclosure seeks a sense of luxury and quality of sanitary ware from a viewpoint different from image clarity.

A sanitary ware provided herein can include a ceramic base material, an upper glaze layer positioned on a surface of the ceramic base material, and an intermediate layer positioned between the ceramic base material and the upper glaze layer, wherein the sanitary ware satisfies at least one of the following conditions: a pore area ratio of 3% or less in terms of a ratio of an area of pores present in a cut surface obtained by cutting the upper glaze layer along the thickness direction thereof, relative to an area of the cut surface, an average pore size of 50 μm or less as measured with respect to the cut surface obtained by cutting the upper glaze layer along the thickness direction thereof, and a difference of 50 μm or less between the maximum and minimum values of the thickness of the upper glaze layer.

### BRIEF DESCRIPTION OF THE DRAWINGS

The invention will now be described, by way of example only, with reference to the accompanying drawings, in which:

FIG. 1 is a cross-sectional view of sanitary ware according to some embodiments; and

FIG. 2 is an example of a differential thermal analysis (DTA) curve of an upper glaze layer of the sanitary ware, according to some embodiments.

### DETAILED DESCRIPTION OF THE EMBODIMENT

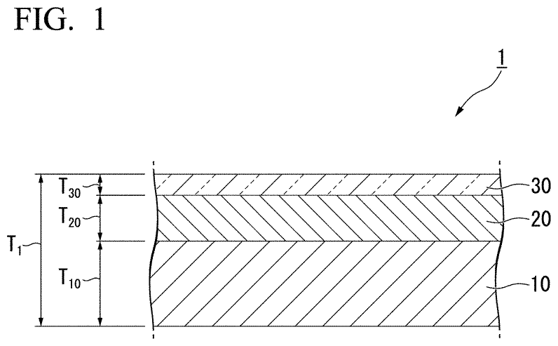

Sanitary ware 1 shown in FIG. 1 includes a ceramic base material 10, an upper glaze layer 30 positioned on a surface of the ceramic base material 10, and an intermediate layer 20 positioned between the ceramic base material 10 and the upper glaze layer 30.

As used herein, the term “sanitary ware” means earthenware products used around toilets and washrooms. Examples of the sanitary ware 1 include a urinal, a toilet bowl, a toilet bowl tank, a washbowl on a washstand, a hand washer and the like. In the present specification, the term “ware” means earthenware obtained by applying a glaze to a surface thereof using feldspar, pottery stone, kaolin, and clay as raw materials, and firing it.

A thickness T1 of the sanitary ware 1 is not particularly limited. In some embodiments the range of thickness T1 may be 1 to 50 mm. In some embodiments, the range of thickness T1 may be 2 to 30 mm. In some embodiments, the range of thickness T1 may be 3 to 20 mm. When the thickness T1 is equal to or more than the above lower limit value (1 mm or more), the strength of the sanitary ware 1 is likely to be enhanced. When the thickness T1 is equal to or thinner than the above upper limit value (50 mm or less), the sanitary ware 1 is capable of being made lightweight so that it becomes easy to handle. The thickness T1 of the sanitary ware 1 can be measured, for example, using a vernier caliper.

In some embodiments, the range of image clarity of the sanitary ware 1 may be from 80 to 99. In some embodiments, the range of image clarity of the sanitary ware 1 may be from 85 to 99. In some embodiments, the range of image clarity of the sanitary ware 1 may be from 90 to 99. In some embodiments, image clarity of the sanitary ware 1 may be 80 or more. In some embodiments, the image clarity of the sanitary ware 1 may be 85 or more. In some embodiments, the image clarity of the sanitary ware 1 may be 90 or more. When the image clarity of the sanitary ware 1 is equal to or more than the lower limit value (80 or more), it is easy to give an impression of high quality. In the present specification, image clarity refers to a distinctness of image (DOI) value measured by a Wave-Scan DOI measuring device (Wave-Scan-DUAL, manufactured by BYK Gardner).

Ceramic base material 10 may be a base material made by forming a ceramic base material composition (also referred to as ceramic base material sludge) into a predetermined shape using a plaster mold or a resin mold and firing it at 1,100 to 1,300° C. The ceramic base material composition contains one or more materials selected from feldspar, pottery stone, kaolin, clay and the like as raw materials. The ceramic base material composition contains water. The range of the content of water relative to the total mass of the ceramic base material composition may be 30 to 50 mass %. The range of the content of water relative to the total mass of the ceramic base material composition may be 30 to 40 mass %.

A thickness T10 of the ceramic base material 10 is not particularly limited. The lower limit value of the thickness T10 of the ceramic base material 10 may be 1 mm. The lower limit value of the thickness T10 of the ceramic base material 10 may be 2 mm. The lower limit value of the thickness T10 of the ceramic base material 10 may be 3 mm. The upper limit value of the thickness T10 of the ceramic base material 10 may be 50 mm. The upper limit value of the thickness T10 of the ceramic base material 10 may be 30 mm. The upper limit value of the thickness T10 of the ceramic base material 10 may be 20 mm. In some embodiments, the range of thickness T10 of the ceramic base material 10 may be 1 to 50 mm. In some embodiments, the range of thickness T10 of the ceramic base material 10 may be 2 to 30 mm. In some embodiments, range of thickness T10 of the ceramic base material 10 may be 3 to 20 mm. When the thickness T10 is equal to or more than the above lower limit value (1 mm or more), the strength of the ceramic base material 10 is likely to be enhanced. When the thickness T10 is equal to or less than the above upper limit value (50 mm or less), the ceramic base material 10 is capable of being made lightweight so that it becomes easy to handle. The thickness T10 of the ceramic base material 10 can be measured, for example, using a vernier caliper.

The upper glaze layer 30 is a fired product of an upper glaze layer composition for sanitary ware (hereinafter, also simply referred to as an upper glaze layer composition). The upper glaze layer 30 is a layer made of glaze (a glazing agent) for forming a layer positioned on an outermost surface of the sanitary ware 1. The upper glaze layer composition is a so-called glaze. The upper glaze layer composition is slurry (sludge) in which glaze raw materials are dispersed in water. The glaze raw materials are one or more materials selected from silica sand, feldspar, lime, clay, etc. In some embodiments, the range of the content of water relative to the total mass of the upper glaze layer composition may be 40 to 80 mass %. In some embodiments, the range of the content of water relative to the total mass of the upper glaze layer composition may be 40 to 70 mass %.

An average particle size of a solid content contained in the upper glaze layer composition may be 20 μm or less. The average particle size of the solid content may be 15 μm or less. The average particle size of the solid content may be 10 μm or less. When the average particle size of the solid content contained in the upper glaze layer composition is equal to or less than the above upper limit value (20 μm or less), it is easy to lower a melting start temperature of the solid content contained in the upper glaze layer composition. A lower limit value of the average particle size of the solid content contained in the upper glaze layer composition is not particularly limited, and is, for example, 0.1 μm or more. In some embodiments, the range of the average particle size of the solid content contained in the upper glaze layer composition may be 0.1 μm or more and 20 μm or less. In some embodiments, the range of the average particle size of the solid content may be 0.1 μm or more and 15 μm or less. In some embodiments, the range of the average particle size of the solid content may be 0.1 μm or more and 10 μm or less. The average particle size of the solid content contained in the upper glaze layer composition can be adjusted, for example, by grinding the glaze raw materials. For example, a ball mill can be exemplified as a tool for grinding the glaze raw materials.

In the present specification, the “average particle size” means a 50% average particle size (D50). D50 is a median diameter on a number basis, and means an average particle size at 50% in a cumulative distribution. The particle size can be measured, for example, using a laser diffraction type particle size distribution-measuring device (“MT3300EX (model number),” manufactured by Nikkiso Co., Ltd.). The solid content contained in the upper glaze layer composition is dried materials of the upper glaze layer composition.

In some embodiments, the upper glaze layer composition may comprise a composition containing 5 to 25 parts by mass of silica sand, 20 to 40 parts by mass of feldspar, 5 to 15 parts by mass of lime, and 1 to 5 parts by mass of clay. The upper glaze layer composition may include a frit in addition to the above. The frit is obtained by melting a frit raw material at 1,300° C. or higher and then cooling to produce an amorphous glass. When the upper glaze layer composition contains the frit, the melting start temperature of the upper glaze layer composition may be lowered. In addition, the upper glaze layer composition may include the frit so that the upper glaze layer composition is easily melted to be more uniform and the number of pores in the upper glaze layer is easily reduced. As the frit raw material, a composition which contains 40 to 70 mass % of silicon dioxide (SiO2), 5 to 15 mass % of aluminum oxide (Al2O3), and 10 to 50 mass % of a total of sodium oxide (Na2O), potassium oxide (K2O), calcium oxide (CaO), magnesium oxide (MgO), zinc oxide (ZnO), strontium oxide (SrO), barium oxide (BaO) and boron oxide (B2O3), with respect to the total mass of the frit raw material, can be exemplified. The total content of each component in the frit raw material is adjusted such that it does not exceed 100 mass % with respect to the total mass of the frit raw material.

When the upper glaze layer composition contains the frit, the lower limit of the content of the frit relative to the total mass of the solid content contained in the upper glaze layer composition may be 50 mass %. The lower limit of the content of the frit relative to the total mass of the solid content contained in the upper glaze layer composition may be 70 mass %. The upper limit of the content of the frit relative to the total mass of the solid content contained in the upper glaze layer composition may be 100 mass %. For example, the range of the content of the frit relative to the total mass of the solid content contained in the upper glaze layer composition may be 50 to 100 mass %. The range of the content of the frit relative to the total mass of the solid content contained in the upper glaze layer composition may be 70 to 100 mass %. When the content of the frit is equal to or more than the above lower limit value (50 mass % or more), the melting start temperature of the upper glaze layer composition is easily lowered. The content of the frit relative to the total mass of the solid content contained in the upper glaze layer composition is adjusted such that it does not exceed 100 mass %.

The melting start temperature of the upper glaze layer composition can be defined by any of the first melting temperature, the second melting temperature, and the third melting temperature. The first melting temperature is measured by the following measurement method 1-1.

<Measurement Method 1-1>

A differential thermal analysis (DTA) measurement is performed using alumina powder as a reference substance and the dried materials of the upper glaze layer composition for sanitary ware as a sample powder, and a DTA curve is obtained. In a region exceeding 700° C. in the obtained DTA curve, a temperature of the reference substance at the earliest inflection point where a potential difference ΔV decreases is taken as the first melting temperature. The potential difference ΔV corresponds to a value ΔT obtained by subtracting a temperature of the reference substance from a temperature of the sample powder. A temperature of the reference substance at the earliest inflection point where the potential difference ΔV increases in a temperature region higher than the first melting temperature is taken as the second melting temperature.

The DTA curve is obtained by performing the DTA measurement using a differential thermal analysis (DTA) device. The DTA measurement may be a thermogravimetric differential thermal analysis measurement (TG-DTA) measurement. In the DTA measurement, alumina powder is used as the reference substance, and the dried materials of the upper glaze layer composition are used as the sample powder. The dried materials of the upper glaze layer composition are obtained, for example, by heating the upper glaze layer composition to 20 to 110° C. to evaporate the water. The amount of water with respect to the total mass of the dried materials of the upper glaze layer composition is, for example, 0 to 1 mass %. In the DTA measurement, the potential difference ΔV is measured as a function of temperature while changing the temperature of the sample powder and the temperature of the reference substance using a specific program. The potential difference ΔV corresponds to the value ΔT obtained by subtracting the temperature of the reference substance from the temperature of the sample powder ((the temperature of the sample powder)−(the temperature of the reference substance)). In the DTA curve, among inflection points appearing in a region where the temperature of the reference substance exceeds 700° C., the earliest inflection point where the potential difference ΔV decreases is taken as the first inflection point. The temperature of the reference substance at the first inflection point is taken as the first melting temperature. Among inflection points appearing in a temperature region higher than the first melting temperature, the earliest inflection point where the potential difference ΔV increases is taken as the second inflection point. The temperature of the reference substance at the second inflection point is taken as the second melting temperature.

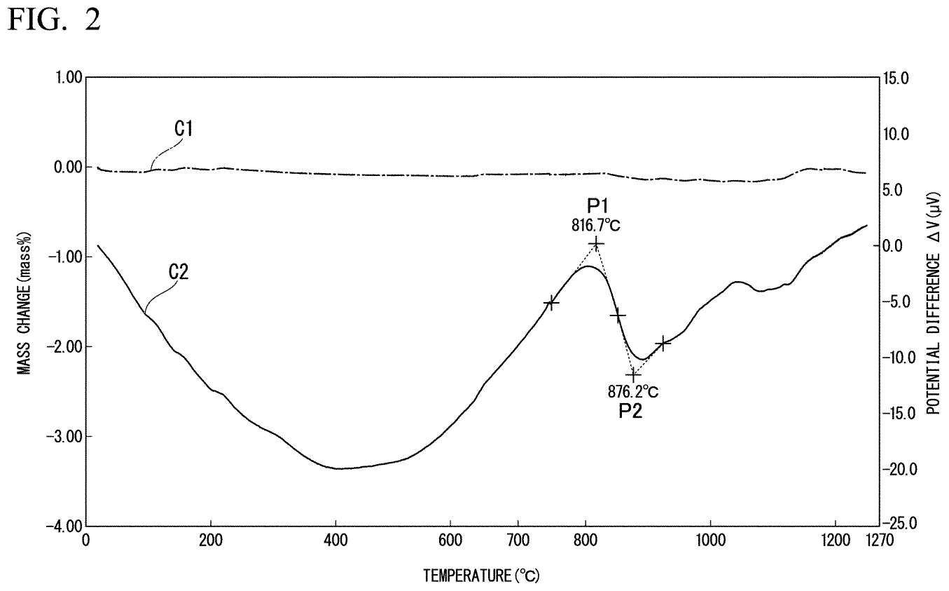

The TG-DTA graph shown in FIG. 2 is obtained when the TG-DTA measurement of the upper glaze layer composition for forming the upper glaze layer 30 of the sanitary ware 1 is performed. In the TG-DTA graph, the horizontal axis represents the temperature (° C.) of the reference substance. The first axis of the vertical axis represents a mass change (mass %) of the sample powder. The second axis of the vertical axis represents the potential difference ΔV (μV). The potential difference ΔV corresponds to the value ΔT obtained by subtracting the temperature of the reference substance from the temperature of the sample powder. In FIG. 2, a curve C1 represents a TG curve. A curve C2 represents a DTA curve. In the curve C2, the potential difference ΔV increases as the temperature of the reference substance increases, and the first inflection point P1 appears in the region where the temperature of the reference substance exceeds 700° C. At the first inflection point P1, it is considered that the upper glaze layer composition starts melting and a glass structure of the upper glaze layer composition starts to be loosened. An intersection point between a tangent drawn to the curve C2 when the slope of the curve C2 (an amount of increase of ΔV/an amount of increase of the temperature of the reference substance) is a maximum and a tangent drawn to the curve C2 when the slope of the curve C2 is a minimum is given as the first inflection point P1. The temperature of the reference substance at the first inflection point P1 is the first melting temperature. The first melting temperature is determined in the same manner as in a method of determining an extrapolation melting start temperature in a general TG-DTA graph (see JIS K7121-1987). In the curve C2, ΔV decreases after the first inflection point P1 appears, and the curve C2 has the second inflection point P2 in which ΔV increases again. At the second inflection point P2, it is considered that the upper glaze layer composition is melted and the glass structure of the upper glaze layer composition is completely loosened. An intersection point between a tangent drawn to C2 when the slope of C2 is a minimum and a tangent drawn to C2 when the slope of C2 becomes positive is given as the second inflection point P2. The temperature of the reference substance at the second inflection point P2 is the second melting temperature. The second melting temperature is determined in the same manner as in a method of determining a melting peak temperature in a general TG-DTA graph (see JIS K7121-1987).

In the DTA measurement, the lower limit value of the mass of the reference substance may be 5 mg. The upper limit value of the mass of the reference substance may be 50 mg. For example, the range of the mass of the reference substance may be 5 to 50 mg. In the DTA measurement, the lower limit value of the mass of the sample powder may be 5 mg. The upper limit value of the mass of the sample powder may be 50 mg. For example, the range of the mass of the sample powder may be 5 to 50 mg. In the DTA measurement, the lower limit value of the heating temperature for obtaining the dried materials of the upper glaze layer composition may be 20° C. The upper limit value of the heating temperature for obtaining the dried materials of the upper glaze layer composition may be 110° C. For example, the range of the heating temperature for obtaining the dried materials of the upper glaze layer composition may be 20 to 110° C. In the DTA measurement, the lower limit value of the heating rate at the time of heating the sample powder may be 2° C./minute. The upper limit value of the heating rate at the time of heating the sample powder may be 10° C./minute. For example, the range of the heating rate at the time of heating the sample powder may be 2 to 10° C./minute.

The lower limit value of the first melting temperature of the upper glaze layer composition may be 800° C. The lower limit value of the first melting temperature of the upper glaze layer composition may be 820° C. The lower limit value of the first melting temperature of the upper glaze layer composition may be 840° C. The upper limit value of the first melting temperature of the upper glaze layer composition may be 1,050° C. The upper limit value of the first melting temperature of the upper glaze layer composition may be 1,000° C. The upper limit value of the first melting temperature of the upper glaze layer composition may be 950° C. For example, the range of the first melting temperature of the upper glaze layer composition may be 800 to 1,050° C. The range of the first melting temperature of the upper glaze layer composition may be 820 to 1,000° C. The range of the first melting temperature of the upper glaze layer composition may be 840 to 950° C. When the first melting temperature of the upper glaze layer composition is equal to or higher than the above lower limit value (800° C. or more), generation of bubbles when firing the upper glaze layer composition is easily inhibited. When the first melting temperature of the upper glaze layer composition is equal to or less than the upper limit value (1,000° C. or less), the bubbles generated when firing the upper glaze layer composition easily diffuse into the atmosphere.

The second melting temperature is measured by the above measurement method 1-1. The lower limit value of the second melting temperature of the upper glaze layer composition may be 850° C. The lower limit value of the second melting temperature of the upper glaze layer composition may be 870° C. The lower limit value of the second melting temperature of the upper glaze layer composition may be 900° C. The upper limit value of the second melting temperature of the upper glaze layer composition may be 1150° C. The upper limit value of the second melting temperature of the upper glaze layer composition may be 1100° C. The upper limit value of the second melting temperature of the upper glaze layer composition may be 1050° C. For example, the range of the second melting temperature of the upper glaze layer composition may be 850 to 1,150° C. The range of the second melting temperature of the upper glaze layer composition may be 870 to 1,100° C. The range of the second melting temperature of the upper glaze layer composition may be 900 to 1,050° C. When the second melting temperature of the upper glaze layer composition is equal to or higher than the above lower limit value (850° C. or more), generation of bubbles when firing the upper glaze layer composition is easily inhibited. When the second melting temperature of the upper glaze layer composition is equal to or less than the above upper limit value (1,150° C. or less), the bubbles generated when firing the upper glaze layer composition easily diffuse into the atmosphere.

The lower limit value of the difference between the second melting temperature and the first melting temperature of the upper glaze layer composition (also referred to as the upper glaze layer melting temperature difference) may be 50° C. The lower limit value of the upper glaze layer melting temperature difference may be 60° C. The lower limit value of the upper glaze layer melting temperature difference may be 70° C. The upper limit value of the upper glaze layer melting temperature difference may be 120° C. The upper limit value of the upper glaze layer melting temperature difference may be 100° C. The upper limit value of the upper glaze layer melting temperature difference may be 90° C. For example, the range of the upper glaze layer melting temperature difference may be 50 to 120° C. The range of the upper glaze layer melting temperature difference may be 60 to 100° C. The range of the upper glaze layer melting temperature difference may be 70 to 90° C. When the upper glaze layer melting temperature difference is equal to or more than the above lower limit value (50° C. or more), an average pore size of pores generated when the upper glaze layer composition is fired is easily reduced. When the upper glaze layer melting temperature difference is equal to or less than the above upper limit value (120° C. or less), generation of pores when firing the upper glaze layer composition is easily inhibited. The upper glaze layer melting temperature difference is determined by subtracting the first melting temperature of the upper glaze layer composition from the second melting temperature of the upper glaze layer composition.

The first melting temperature of the upper glaze layer composition can be adjusted on the basis of a type of the glaze raw material, a blending proportion of the glaze raw material, the average particle size of the solid content of the upper glaze layer composition, and a combination thereof. The second melting temperature of the upper glaze layer composition can be adjusted similarly to the first melting temperature of the upper glaze layer composition.

The third melting temperature is measured by the following measurement method 1-2.

<Measurement Method 1-2>

The dried materials of the upper glaze layer composition for sanitary ware are press-molded to obtain a cylindrical sample. Light is radiated while heating the obtained cylindrical sample. A light amount of the reflected light reflected by a surface of the cylindrical sample is measured. The earliest temperature where the light amount of the reflected light is ten times or more the light amount of the reflected light detected at the beginning of glistening is taken as the third melting temperature.

In the measurement method 1-2, the cylindrical sample is obtained by press-molding the dried materials of the upper glaze layer composition for sanitary ware. The lower limit value of the diameter of the cylindrical sample may be 2 mm. The upper limit value of the diameter of the cylindrical sample may be 10 mm. For example, the range of the diameter of the cylindrical sample may be 2 to 10 mm. The lower limit value of the height of the cylindrical sample may be 5 mm. The upper limit value of the height of the cylindrical sample may be 20 mm. For example, the range of the height of the cylindrical sample may be 5 to 20 mm. The lower limit value of the mass of the cylindrical sample may be 100 mg. The upper limit value of the mass of the cylindrical sample may be 500 mg. For example, the range of the mass of the cylindrical sample may be 100 to 500 mg. The lower limit value of the pressure for press-molding the dried materials of the upper glaze layer composition may be 10 MPa. The upper limit value of the pressure for press-molding the dried materials of the upper glaze layer composition may be 50 MPa. For example, the range of the pressure for press-molding the dried materials of the upper glaze layer composition may be 10 to 50 MPa. The light amount of the reflected light is a value obtained such that the reflected light is taken by a digital camera with a telephoto lens and is converted to the number of pixels by an image processing system. The light amount of the reflected light when heating the cylindrical sample is measured every 1° C. The “beginning of glistening” means that the light amount of the reflected light reflected by the surface of the cylindrical sample is not zero. The lower limit value of the heating rate at the time of heating the cylindrical sample may be 1° C./minute. The upper limit value of the heating rate at the time of heating the cylindrical sample may be 10° C./minute. For example, the range of the heating rate at the time of heating the cylindrical sample may be 1 to 10° C./minute. The lower limit value of the light amount of the light radiated to the cylindrical sample may be 500 lumens. The upper limit value of the light amount of the light radiated to the cylindrical sample may be 2,000 lumens. For example, the range of the light amount of the light radiated to the cylindrical sample may be 500 to 2,000 lumens. At the third melting temperature, it is considered that the upper glaze layer composition starts melting and the glass structure of the upper glaze layer composition is completely loosened.

The lower limit value of the third melting temperature of the upper glaze layer composition may be 850° C. The lower limit value of the third melting temperature of the upper glaze layer composition may be 870° C. The lower limit value of the third melting temperature of the upper glaze layer composition may be 900° C. The upper limit value of the third melting temperature of the upper glaze layer composition may be 1,150° C. The upper limit value of the third melting temperature of the upper glaze layer composition may be 1,100° C. The upper limit value of the third melting temperature of the upper glaze layer composition may be 1,050° C. For example, the range of the third melting temperature of the upper glaze layer composition may be 850 to 1,150° C. The range of the third melting temperature of the upper glaze layer composition may be 870 to 1,100° C. The range of the third melting temperature of the upper glaze layer composition may be 900 to 1,050° C. When the third melting temperature of the upper glaze layer composition is equal to or higher than the above lower limit value (850° C. or more), generation of bubbles when firing the upper glaze layer composition is easily inhibited. When the third melting temperature of the upper glaze layer composition is equal to or less than the above upper limit value (1,150° C. or less), the bubbles generated when firing the upper glaze layer composition easily diffuse into the atmosphere.

The third melting temperature of the upper glaze layer composition can be adjusted similarly to the first melting temperature of the upper glaze layer composition.

When the melting start temperature of the upper glaze layer 30 is determined from the sanitary ware 1 including the upper glaze layer 30, the first melting temperature and the second melting temperature are measured by the following measurement method 2-1.

<Measurement Method 2-1>

A DTA measurement is performed using alumina powder as a reference substance and the powder of the upper glaze layer 30 as a sample powder, and a DTA curve is obtained. In the region exceeding 700° C. in the obtained DTA curve, a temperature of the reference substance at the earliest inflection point where the potential difference ΔV (μV) decreases is taken as the first melting temperature. The potential difference ΔV (μV) corresponds to the value ΔT obtained by subtracting the temperature of the reference substance from the temperature of the sample powder. In a temperature region higher than the first melting temperature, a temperature of the reference substance at the earliest inflection point where the potential difference ΔV increases is taken as the second melting temperature.

The powder of the upper glaze layer 30 may be obtained, for example, by appropriately cutting and grinding the upper glaze layer 30. Conditions for the DTA measurement are the same as the conditions for the DTA measurement in the above measurement method 1-1. The first melting temperature of the upper glaze layer 30 is the same as the first melting temperature of the upper glaze layer composition. The second melting temperature of the upper glaze layer 30 is the same as the second melting temperature of the upper glaze layer composition. A difference between the second melting temperature and the first melting temperature of the upper glaze layer 30 is the same as the difference between the second melting temperature and the first melting temperature of the upper glaze layer composition (upper glaze layer melting temperature difference).

When the third melting temperature of the upper glaze layer 30 is obtained from the sanitary ware 1 including the upper glaze layer 30, the measurement is performed by the following measurement method 2-2.

<Measurement Method 2-2>

The powder of the upper glaze layer 30 is press-molded to obtain a cylindrical sample. Light is radiated while heating the obtained cylindrical sample. A light amount of the reflected light reflected by a surface of the cylindrical sample is measured. The earliest temperature at which the light amount of the reflected light is ten times or more the light amount of the reflected light detected at the beginning of glistening is taken as the third melting temperature.

The powder of the upper glaze layer 30 may be obtained, for example, by appropriately cutting and grinding the upper glaze layer 30. Conditions for obtaining the cylindrical sample are the same as the conditions for obtaining the cylindrical sample in the above measurement method 1-2. The third melting temperature of the upper glaze layer 30 is the same as the third melting temperature of the upper glaze layer composition.

In the present specification, “pore” means a pore actually contained in the upper glaze layer 30 and the intermediate layer 20. Pores can be generated, for example, due to at least one of oxidation reactions, decomposition reactions and voids and the like. The oxidation reactions are based on components contained in at least one of the upper glaze layer 30, the ceramic base material 10, and an intermediate layer composition. The decomposition reactions are based on the components contained in at least one of the upper glaze layer 30, the ceramic base material 10, and an intermediate layer composition. The voids are included in at least one of the upper glaze layer 30, the ceramic base material 10, and the intermediate layer composition. The pores are counted by binarizing a brightness of an image using image-processing software in the image obtained by observing a cut surface of the upper glaze layer 30 with a microscope or the like, and determining a relatively dark place as a pore. A size of the pores to be counted is set to be a diameter of 2 μm or more by converting the pores in the cut surface to a perfect circle.

The pores to be counted can be determined, for example, by the following procedure. The sanitary ware 1 is cut along a thickness direction of the upper glaze layer 30 using a small sample cutter. The cut surface after cutting is observed with a microscope (DSX510, manufactured by Olympus Corporation) at a magnification of 125 times. In the observed image, the brightness of the image is binarized using image-processing software, and one having a size of πμm2 (an area equivalent to a pore of 2 μm in diameter) or more in each area of a relatively dark place is detected as a pore.

The ratio of the area of the pores to the area of the cut surface obtained by cutting the upper glaze layer 30 along the thickness direction (hereinafter, also referred to as a “pore area ratio of the upper glaze layer 30”) is 3% or less. The pore area ratio of the upper glaze layer 30 may be 2.30% or less. The pore area ratio of the upper glaze layer 30 may be 2% or less. The pore area ratio of the upper glaze layer 30 may be 1.53% or less. The pore area ratio of the upper glaze layer 30 may be 1.26% or less. The pore area ratio of the upper glaze layer 30 may be 0.95% or less. When the pore area ratio of the upper glaze layer 30 is equal to or less than the above upper limit value (3% or less), irregular reflection of the light incident on the upper glaze layer 30 caused by the pores in the upper glaze layer 30 is easily inhibited. For this reason, the “depth” of the sanitary ware 1 is more easily improved. Similarly, when the pore area ratio of the upper glaze layer 30 is equal to or less than the above upper limit value (3% or less), irregular reflection of the light incident on the upper glaze layer 30 caused by the pores in the upper glaze layer 30 is easily inhibited. For this reason, the “beauty” of the sanitary ware 1 is more easily improved. A lower limit value of the pore area ratio of the upper glaze layer 30 is not particularly limited, but is usually 0.01% or more. For example, the pore area ratio of the upper glaze layer 30 may be 0.01% or more and 3% or less. The pore area ratio of the upper glaze layer 30 may be 0.01% or more and 2.30% or less. The pore area ratio of the upper glaze layer 30 may be 0.01% or more and 2% or less. The pore area ratio of the upper glaze layer 30 may be 0.01% or more and 1.53% or less. The pore area ratio of the upper glaze layer 30 may be 0.01% or more and 1.26% or less. The pore area ratio of the upper glaze layer 30 may be 0.01% or more and 0.95% or less. The pore area ratio (%) of the upper glaze layer 30 can be obtained by dividing a total area (mm2) of the pores detected in the image observed using the above-mentioned microscope or the like by a visual field area (mm2) in the observed image.

The average pore size of pores in the cut surface obtained by cutting the upper glaze layer 30 along the thickness direction (hereinafter also referred to as an “average pore size of the upper glaze layer 30”) may be 50 μm or less. The average pore size of the upper glaze layer 30 may be 40 μm or less. The average pore size of the upper glaze layer 30 may be 30 μm or less. The average pore size of the upper glaze layer 30 may be 24 μm or less. The average pore size of the upper glaze layer 30 may be 15 μm or less. When the average pore size of the upper glaze layer 30 is equal to or less than the above upper limit value (50 μm or less), irregular reflection of the light incident on the upper glaze layer 30 caused by the pores in the upper glaze layer 30 is easily inhibited. For this reason, the “depth” of the sanitary ware 1 is more easily improved. Similarly, when the average pore size of the upper glaze layer 30 is equal to or less than the above upper limit value (50 μm or less), irregular reflection of the light incident on the upper glaze layer 30 caused by the pores in the upper glaze layer 30 is easily inhibited. For this reason, the “beauty” of the sanitary ware 1 is more easily improved. A lower limit value of the average pore size of the upper glaze layer 30 is 2 μm. For example, the average pore size of the upper glaze layer 30 may be 2 μm or more and 50 μm or less. The average pore size of the upper glaze layer 30 may be 2 μm or more to 40 μm or less. The average pore size of the upper glaze layer 30 may be 2 μm or more to 30 μm or less. The average pore size of the upper glaze layer 30 may be 2 μm or more to 24 μm or less. The average pore size of the upper glaze layer 30 may be 2 μm or more to 15 μm or less. The average pore size (μm) in the upper glaze layer 30 is an average value obtained such that, in the image observed using a microscope or the like described above, the pore size (diameter) is calculated based on a perfect circle converted from an area of each portion detected as a pore, and a total of the pore sizes is divided by the number of detected pores to obtain the average value.

The number of pores in the cut surface obtained by cutting the upper glaze layer 30 along the thickness direction (hereinafter, also referred to as a “number of pores in the cut surface of the upper glaze layer 30”) may be 120 or less per 1 mm2 The number of pores in the cut surface of the upper glaze layer 30 may be 100 or less per 1 mm2 The number of pores in the cut surface of the upper glaze layer 30 may be 80 or less per 1 mm2 The number of pores in the cut surface of the upper glaze layer 30 may be 67 or less per 1 mm2 The number of pores in the cut surface of the upper glaze layer 30 may be 48 or less per 1 mm2 The number of pores in the cut surface of the upper glaze layer 30 may be 27 or less per 1 mm2 When the number of pores in the cut surface of the upper glaze layer 30 is equal to or less than the above upper limit value (120 or less), irregular reflection of light incident on the upper glaze layer 30 caused by the pores in the upper glaze layer 30 is easily inhibited. For this reason, the “depth” of the sanitary ware 1 is more easily improved. Similarly, when the number of pores in the cut surface of the upper glaze layer 30 is equal to or less than the above upper limit value (120 or less), irregular reflection of light incident on the upper glaze layer 30 caused by the pores in the upper glaze layer 30 is easily inhibited. For this reason, the “beauty” of the sanitary ware 1 is more easily improved. A lower limit value of the number of pores in the cut surface of the upper glaze layer 30 is not particularly limited, but is usually 1 or more. For example, the number of pores in the cut surface of the upper glaze layer 30 may be 1 or more and 120 or less per 1 mm2 The number of pores in the cut surface of the upper glaze layer 30 may be 1 or more and 100 or less per 1 mm2 The number of pores in the cut surface of the upper glaze layer 30 may be 1 or more and 80 or less per 1 mm2 The number of pores in the cut surface of the upper glaze layer 30 may be 1 or more and 67 or less per 1 mm2 The number of pores in the cut surface of the upper glaze layer 30 may be 1 or more and 48 or less per 1 mm2 The number of pores in the cut surface of the upper glaze layer 30 may be 1 or more and 27 or less per 1 mm2 The number of pores (pieces/mm2) in the cut surface of the upper glaze layer 30 can be obtained by dividing the number of pores detected in the image observed using the above-described microscope or the like by a visual field area (mm2) in the observed image.

The lower limit value of the thickness T30 of the upper glaze layer 30 may be 100 μm. The lower limit value of the thickness T30 of the upper glaze layer 30 may be 150 μm. The lower limit value of the thickness T30 of the upper glaze layer 30 may be 200 μm. The lower limit value of the thickness T30 of the upper glaze layer 30 may be 242 μm. The lower limit value of the thickness T30 of the upper glaze layer 30 may be 253 μm. The upper limit value of the upper glaze layer 30 may be 1000 μm. The upper limit value of the upper glaze layer 30 may be 800 μm. The upper limit value of the upper glaze layer 30 may be 600 μm. The upper limit value of the upper glaze layer 30 may be 500 μm. The upper limit value of the upper glaze layer 30 may be 349 μm. For example, the range of the thickness T30 of the upper glaze layer 30 may be 100 μm or more. The range of the thickness T30 of the upper glaze layer 30 may be 100 to 1,000 μm. The range of the thickness T30 of the upper glaze layer 30 may be 150 to 800 μm. The range of the thickness T30 of the upper glaze layer 30 may be 200 to 600 μm. The range of the thickness T30 of the upper glaze layer 30 may be 242 to 500 μm. The range of the thickness T30 of the upper glaze layer 30 may be 253 to 349 μm. When the thickness T30 is equal to or more than the above lower limit value (100 μm or more), the surface of the upper glaze layer 30 is easily flattened. When the thickness T30 is equal to or less than the above upper limit value (1,000 μm or less), the bubbles in the upper glaze layer composition are easily discharged outside of the upper glaze layer 30.

The thickness T30 of the upper glaze layer 30 can be determined, for example, by the following procedure. The sanitary ware 1 is cut along the thickness direction of the upper glaze layer 30 using a small sample cutter. The cut surface after cutting is observed with a microscope (DSX510, manufactured by Olympus Corporation) at a magnification of 125 times. In the observed image, the distance between a boundary line (also referred to as an upper-intermediate boundary line) between the upper glaze layer 30 and the intermediate layer 20 and the surface of the upper glaze layer 30 is measured at any 20 places. An arithmetic average value of the measured distances is taken as the thickness T30 of the upper glaze layer 30. The portions at which the sanitary ware 1 is cut are not particularly limited, and portions easily seen by the human eye are preferable. Examples of the portions easily seen by the human eye include a bowl surface of a washbowl, a top surface of a washbowl, a top surface of a urinal, a rim portion of a toilet bowl, a bowl surface of a toilet bowl, a side surface of a toilet bowl and the like.

The difference T30Δ between the maximum value T30MAX of the thickness T30 of the upper glaze layer 30 and the minimum value T30MIN of the thickness T30 of the upper glaze layer 30 may be 70 μm or less. The difference T30Δ may be 50 μm or less. The difference T30Δ may be 40 μm or less. The difference T30Δ may be 30 μm or less. When the difference T30Δ is equal to or less than the above upper limit value (70 μm or less), irregular reflection of the light at an interface between the upper glaze layer 30 and the intermediate layer 20 is easily inhibited. As a result, the “depth” of the sanitary ware 1 is more easily improved. Similarly, when the difference T30Δ is equal to or less than the above upper limit value (70 μm or less), irregular reflection of the light at the interface between the upper glaze layer 30 and the intermediate layer 20 is easily inhibited. As a result, the “beauty” of the sanitary ware 1 is more easily improved. A lower limit value of the difference T30Δ is not particularly limited, but is usually 0.1 μm or more. For example, the difference T30Δ may be 0.1 μm or more and 70 μm or less. The difference T30Δ may be 0.1 μm or more and 50 μm or less. The difference T30Δ may be 0.1 μm or more to 40 μm or less. The difference T30Δ may be 0.1 μm or more and 30 μm or less.

A ratio of the difference T30Δ to the thickness T30 (hereinafter also referred to as a “T30Δ/T30 ratio”) may be 25% or less. The T30Δ/T30 ratio may be 20% or less. The T30Δ/T30 ratio may be 10% or less. When the T30Δ/T30 ratio is equal to or less than the upper limit value (25% or less), irregular reflection of the light at the interface between the upper glaze layer 30 and the intermediate layer 20 is easily inhibited. As a result, the “depth” of the sanitary ware 1 is more easily improved. Similarly, when the T30Δ/T30 ratio is equal to or less than the upper limit value (25% or less), irregular reflection of the light at the interface between the upper glaze layer 30 and the intermediate layer 20 is easily inhibited. As a result, the “beauty” of the sanitary ware 1 is more easily improved. A lower limit value of the T30Δ/T30 ratio is not particularly limited, but is usually 0.01% or more. For example, the range of the T30Δ/T30 ratio may be 0.01% or more and 25% or less. The range of the T30Δ/T30 ratio may be 0.01% or more and 20% or less. The range of the T30Δ/T30 ratio may be 0.01% or more and 10% or less.

The maximum value T30MAX of the thickness T30 and the minimum value T30MIN of the thickness T30 can be obtained, for example, by the following procedure. Similarly to the procedure for determining the thickness T30 of the upper glaze layer 30, the distance between the surfaces of the upper glaze layer 30 and the upper-intermediate boundary line is measured at any 20 places. Among the 20 measured places, one place with the largest distance between the surface of the upper glaze layer 30 and the upper-intermediate boundary line is taken as the maximum value T30MAX. Among the 20 measured places, one place with the smallest distance between the surface of the upper glaze layer 30 and the upper-intermediate boundary line is taken as the minimum value T30MIN.

The difference T30Δ can be controlled by flattening the interface between the upper glaze layer 30 and the intermediate layer 20. A smoothness of the interface between the upper glaze layer 30 and the intermediate layer 20 can be controlled by the melting start temperature of the intermediate layer composition which will be described later, the average pore size at the cut surface obtained by cutting the intermediate layer 20 along the thickness direction, the ratio of the pore area to the area of the cut surface obtained by cutting the intermediate layer 20 along the thickness direction, and combinations thereof.

The intermediate layer 20 is a fired material of an intermediate layer composition. The intermediate layer 20 is a layer including a glaze positioned between the ceramic base material 10 and the upper glaze layer 30. The intermediate layer composition is a slurry (a sludge) in which a raw material (intermediate layer raw material) for forming the intermediate layer 20 is dispersed in water. The range of the content of water relative to the total mass of the intermediate layer composition-may be 40 to 60 mass %. The range of the content of water relative to the total mass of the intermediate layer composition may be 40 to 50 mass %.

The average particle size of the solid content contained in the intermediate layer composition may be 10 μm or less. The average particle size of the solid content contained in the intermediate layer composition may be 8 μm or less. The average particle size of the solid content contained in the intermediate layer composition may be 6 μm or less. When the average particle size of the solid content contained in the intermediate layer composition is equal to or less than the above upper limit value (10 μm or less), the melting start temperature of the solid content contained in the intermediate layer composition is easily lowered. A lower limit value of the average particle size of the solid content contained in the intermediate layer composition is not particularly limited, and is, for example, 0.05 μm or more. For example, the range of the average particle size of the solid content contained in the intermediate layer composition may be 0.05 μm or more and 10 μm or less. The range of the average particle size of the solid content contained in the intermediate layer composition may be 0.05 μm or more and 8 μm or less. The range of the average particle size of the solid content contained in the intermediate layer composition may be 0.05 μm or more and 6 μm or less. The average particle size of the solid content contained in the intermediate layer composition can be adjusted, for example, by grinding the intermediate layer raw material. For example, a ball mill can be exemplified as a tool for grinding intermediate layer raw materials.

The average particle size of the solid content contained in the intermediate layer composition can be measured by the same method as the average particle size of the solid content contained in the upper glaze layer composition. The solid content contained in the intermediate layer composition is dried materials of the intermediate layer composition.

Examples of the intermediate layer composition include a composition containing 50 to 80 mass % of SiO2, 5 to 40 mass % of Al2O3, and 5 to 30 mass % of a total of Na2O, K2O, CaO, MgO and ZnO with respect to the total mass of the solid content contained in the intermediate layer composition. A total of the content of each component of the solid content contained in the intermediate layer composition is adjusted such that it does not exceed 100 mass % with respect to the total mass of the solid content contained in the intermediate layer composition.

A composition of the intermediate layer composition may include 2 to 16 moles of SiO2 and 0 to 5 moles of Al2O3 as a molar ratio when the sum of the number of moles of Na2O, K2O, CaO, MgO, and ZnO is set to 1.

The intermediate layer composition may contain a frit. The range of the content of the frit relative to the total mass of the solid content contained in the intermediate layer composition may be 0 to 30 mass %. The range of the content of the frit relative to the total mass of the solid content contained in the intermediate layer composition may be 0 to 20 mass %.

The dried materials of the intermediate layer composition (hereinafter also referred to as the intermediate layer raw material) may be a mixture of the dried materials of the ceramic base material composition (hereinafter also referred to as the ceramic base raw material) and the dried materials of the upper glaze layer composition (hereinafter referred to as the glaze raw material). When the intermediate layer raw material is a mixture of the ceramic base raw material and the glaze raw material, a mass ratio represented by the ceramic base raw material/the glaze raw material (hereinafter also referred to as a “ceramic base/glaze ratio”) may be 20/80 to 80/20. The ceramic base/glaze ratio may be 30/70 to 70/30. The ceramic base/glaze ratio may be 40/60 to 60/40. When the ceramic base/glaze ratio is equal to or more than the above lower limit value (20/80 or more), adhesion between the ceramic base material 10 and the intermediate layer 20 is easily increased. When the ceramic base/glaze ratio is equal to or less than the above upper limit value (80/20 or less), the interface between the intermediate layer 20 and the upper glaze layer 30 is easily flattened. From the viewpoint of further improving at least one of the “depth” and the “beauty” of the sanitary ware 1, the intermediate layer raw material may be a mixture of the ceramic base raw material and the glaze raw material. The intermediate layer composition may be a mixture of the ceramic base material composition and the upper glaze layer composition which are mixed together to have the above ceramic base/glaze ratio.

The intermediate layer composition may include a pigment. In some embodiments, the intermediate layer composition contains the pigment so that the intermediate layer 20 is capable of being colored. By coloring the intermediate layer 20, the color of the ceramic base material 10 is capable of being concealed. By concealing the color of the ceramic base material 10, the “beauty” of the sanitary ware 1 is more easily improved. Examples of the pigment include zirconium silicate, aluminum oxide and the like. When the intermediate layer composition contains the pigment, the range of the content of the pigment relative to the total mass of the solid content contained in the intermediate layer composition may be 3 to 15 mass %. The range of the content of the pigment relative to the total mass of the solid content contained in the intermediate layer composition may be 6 to 15 mass %.

The melting start temperature of the intermediate layer composition can be defined by any of the first melting temperature and the second melting temperature. The lower limit value of the first melting temperature of the intermediate layer composition may be 850° C. The lower limit value of the first melting temperature of the intermediate layer composition may be 910° C. The lower limit value of the first melting temperature of the intermediate layer composition may be 930° C. The upper limit value of the first melting temperature of the intermediate layer composition may be 960° C. The upper limit value of the first melting temperature of the intermediate layer composition may be 950° C. For example, the range of the first melting temperature of the intermediate layer composition may be 850 to 960° C. The range of the first melting temperature of the intermediate layer composition may be 910 to 950° C. The range of the first melting temperature of the intermediate layer composition may be 930 to 950° C. When the first melting temperature of the intermediate layer composition is equal to or higher than the above lower limit value (850° C. or more), generation of bubbles when firing the intermediate layer composition is easily inhibited. When the first melting temperature of the intermediate layer composition is equal to or less than the above upper limit value (960° C. or less), the interface between the upper glaze layer 30 and the intermediate layer 20 is easily flattened. The first melting temperature of the intermediate layer composition can be measured in the same method as the first melting temperature of the upper glaze layer composition.

The lower limit value of the difference in temperature between the first melting temperature of the upper glaze layer composition and the first melting temperature of the intermediate layer composition (also referred to as a first temperature difference) may be 10° C. The lower limit value of the first temperature difference may be 30° C. The lower limit value of the first temperature difference may be 60° C. The upper limit value of the first temperature difference may be 120° C. The upper limit value of the first temperature difference may be 115° C. The upper limit value of the first temperature difference may be 110° C. For example, the range of the first temperature difference may be 10 to 120° C. The range of the first temperature difference may be 30 to 115° C. The range of the first temperature difference may be 60 to 110° C. When the first temperature difference is within the above numerical range (10° C. or more and 120° C. or less), the interface between the upper glaze layer 30 and the intermediate layer 20 is easily flattened. As a result, irregular reflection of the light at the interface between the upper glaze layer 30 and the intermediate layer 20 is capable of being inhibited so that the “depth” of the sanitary ware 1 is more easily improved. Similarly, when the first temperature difference is within the above numerical range (10° C. or more and 120° C. or less), the interface between the upper glaze layer 30 and the intermediate layer 20 is easily flattened. As a result, irregular reflection of the light at the interface between the upper glaze layer 30 and the intermediate layer 20 is capable of being inhibited so that the “beauty” of the sanitary ware 1 is more easily improved.

The lower limit value of the second melting temperature of the intermediate layer composition may be 1,090° C. The lower limit value of the second melting temperature of the intermediate layer composition may be 1,095° C. The lower limit value of the second melting temperature of the intermediate layer composition may be 1,100° C. The upper limit value of the second melting temperature of the intermediate layer composition may be 1,230° C. The upper limit value of the second melting temperature of the intermediate layer composition may be 1,225° C. The upper limit value of the second melting temperature of the intermediate layer composition may be 1,220° C. For example, the range of the second melting temperature of the intermediate layer composition may be 1,090 to 1,230° C. The range of the second melting temperature of the intermediate layer composition may be 1,095 to 1,225° C. The range of the second melting temperature of the intermediate layer composition may be 1,100 to 1,220° C. When the second melting temperature of the intermediate layer composition is equal to or higher than the above lower limit value (1,090° C. or more), generation of bubbles when firing the intermediate layer composition is easily inhibited. When the second melting temperature of the intermediate layer composition is equal to or less than the above upper limit value (1,230° C. or less), the interface between the upper glaze layer 30 and the intermediate layer 20 is easily flattened. The second melting temperature of the intermediate layer composition can be measured in the same method as the second melting temperature of the upper glaze layer composition.

The lower limit value of the difference in temperature between the second melting temperature of the upper glaze layer composition and the second melting temperature of the intermediate layer composition (also referred to as a second temperature difference) may be 10° C. The lower limit value of the second temperature difference may be 100° C. The lower limit value of the second temperature difference may be 200° C. The upper limit value of the second temperature difference may be 330° C. The upper limit value of the second temperature difference may be 325° C. The upper limit value of the second temperature difference may be 320° C. For example, the range of the second temperature difference may be 10 to 330° C. The range of the second temperature difference may be 100 to 325° C. The range of the second temperature difference may be 200 to 320° C. When the second temperature difference is within the above numerical range (10° C. or more and 330° C. or less), the interface between the upper glaze layer 30 and the intermediate layer 20 is easily flattened. As a result, irregular reflection of the light at the interface between the upper glaze layer 30 and the intermediate layer 20 is capable of being inhibited so that the “depth” of the sanitary ware 1 is more easily improved. Similarly, when the second temperature difference is within the above numerical range (10° C. or more and 330° C. or less), the interface between the upper glaze layer 30 and the intermediate layer 20 is easily flattened. As a result, irregular reflection of the light at the interface between the upper glaze layer 30 and the intermediate layer 20 is capable of being inhibited so that the “beauty” of the sanitary ware 1 is more easily improved.

The lower limit value of the difference between the second melting temperature and the first melting temperature of the intermediate layer composition (an intermediate layer melting temperature difference) may be 50° C. The lower limit value of the intermediate layer melting temperature difference may be 100° C. The lower limit value of the intermediate layer melting temperature difference may be 230° C. The upper limit value of the intermediate layer melting temperature difference may be 300° C. For example, the range of the intermediate layer melting temperature difference may be 50 to 300° C. The range of the intermediate layer melting temperature difference may be 100 to 300° C. The range of the intermediate layer melting temperature difference may be 230 to 300° C. When the intermediate layer melting temperature difference is equal to or higher than the above lower limit value (50° C. or more), the average pore size of pores generated when firing the intermediate layer composition is easily reduced. When the intermediate layer melting temperature difference is equal to or less than the above upper limit value (300° C. or less), generation of bubbles when firing the intermediate layer composition is easily inhibited. The intermediate layer melting temperature difference is determined by subtracting the first melting temperature of the intermediate layer composition from the second melting temperature of the intermediate layer composition.

The first melting temperature of the intermediate layer composition can be adjusted on the basis of a type of intermediate layer raw material, a blending proportion of the intermediate layer raw material, the average particle size of the solid content of the intermediate layer composition, and combinations thereof. The second melting temperature of the intermediate layer composition can be adjusted similarly to the first melting temperature of the intermediate layer composition.

When obtaining the melting start temperature of the intermediate layer 20 from the sanitary ware 1 including the intermediate layer 20, the first melting temperature and the second melting temperature are measured, using the powder of the intermediate layer 20 as a sample powder, on the basis of the same method as the measurement method 2-1. The powder of the intermediate layer 20 is obtained, for example, by appropriately cutting and grinding the intermediate layer 20. The first melting temperature of the intermediate layer 20 is the same as the first melting temperature of the intermediate layer composition. The second melting temperature of the intermediate layer 20 is the same as the second melting temperature of the intermediate layer composition. The difference between the second melting temperature and the first melting temperature of the intermediate layer 20 is the same as the difference between the second melting temperature and the first melting temperature of the intermediate layer composition (intermediate layer melting temperature difference).

A ratio of the area of the pores to the area of the cut surface obtained by cutting the intermediate layer 20 along the thickness direction (hereinafter, also referred to as a “pore area ratio of the intermediate layer 20”) may be 20% or less. The pore area ratio of the intermediate layer 20 may be 15% or less. The pore area ratio of the intermediate layer 20 may be 12% or less. The pore area ratio of the intermediate layer 20 may be 11.36% or less. The pore area ratio of the intermediate layer 20 may be 9.75% or less. When the pore area ratio of the intermediate layer 20 is equal to or less than the above upper limit value (20% or less), irregular reflection of the light incident on the upper glaze layer 30 caused by the pores in the intermediate layer 20 is easily inhibited. As a result, the irregular reflection of the light at the interface between the upper glaze layer 30 and the intermediate layer 20 is capable of being inhibited so that the “depth” of the sanitary ware 1 is more easily improved. Similarly, when the pore area ratio of the intermediate layer 20 is equal to or less than the above upper limit value (20% or less), irregular reflection of the light incident on the upper glaze layer 30 caused by the pores in the intermediate layer 20 is easily inhibited. As a result, the irregular reflection of the light at the interface between the upper glaze layer 30 and the intermediate layer 20 is capable of being inhibited so that the “beauty” of the sanitary ware 1 is more easily improved. A lower limit value of the pore area ratio of the intermediate layer 20 is not particularly limited, but is usually 1.0% or more. For example, the range of the pore area ratio of the intermediate layer 20 may be 1.0% or more and 20% or less. The range of the pore area ratio of the intermediate layer 20 may be 1.0% or more and 15% or less. The range of the pore area ratio of the intermediate layer 20 may be 1.0% or more and 12% or less. The range of the pore area ratio of the intermediate layer 20 may be 1.0% or more and 11.36% or less. The range of the pore area ratio of the intermediate layer 20 may be 1.0% or more and 9.75% or less. The pore area ratio of the intermediate layer 20 is determined by the same method as the pore area ratio of the upper glaze layer 30.

The average pore size of pores in the cut surface obtained by cutting the intermediate layer 20 along the thickness direction (hereinafter also referred to as an “average pore size of the intermediate layer 20”) may be 25 μm or less. The average pore size of the intermediate layer 20 may be 20 μm or less. The average pore size of the intermediate layer 20 may be 15 μm or less. The average pore size of the intermediate layer 20 may be 14 μm or less. The average pore size of the intermediate layer 20 may be 13 μm or less. When the average pore size of the intermediate layer 20 is equal to or less than the upper limit value (25 μm or less), irregular reflection of the light incident on the upper glaze layer 30 caused by the pores in the intermediate layer 20 is easily inhibited. As a result, the irregular reflection of the light at the interface between the upper glaze layer 30 and the intermediate layer 20 is capable of being inhibited so that the “depth” of the sanitary ware 1 is more easily improved. Similarly, when the average pore size of the intermediate layer 20 is equal to or less than the upper limit value (25 μm or less), irregular reflection of the light incident on the upper glaze layer 30 caused by the pores in the intermediate layer 20 is easily inhibited. As a result, the irregular reflection of the light at the interface between the upper glaze layer 30 and the intermediate layer 20 is capable of being inhibited so that the “beauty” of the sanitary ware 1 is more easily improved. A lower limit value of the average pore size of the intermediate layer 20 may be 2 μm. For example, the range of the average pore size of the intermediate layer 20 may be 2 μm or more and 25 μm or less. The range of the average pore size of the intermediate layer 20 may be 2 μm or more and 20 μm or less. The range of the average pore size of the intermediate layer 20 may be 2 μm or more and 15 μm or less. The range of the average pore size of the intermediate layer 20 may be 2 μm or more and 14 μm or less. The range of the average pore size of the intermediate layer 20 may be 2 μm or more and 13 μm or less. The average pore size of the intermediate layer 20 is determined by the same method as the average pore size of pores in the cut surface of the upper glaze layer 30.

A number of pores in the cut surface obtained by cutting the intermediate layer 20 along the thickness direction (hereinafter, also referred to as a “number of pores in the cut surface of the intermediate layer 20”) may be 1,000 or less per 1 mm2 The number of pores in the cut surface of the intermediate layer 20 may be 700 or less per 1 mm2 The number of pores in the cut surface of the intermediate layer 20 may be 500 or less per 1 mm2 The number of pores in the cut surface of the intermediate layer 20 may be 443 or less per 1 mm2 The number of pores in the cut surface of the intermediate layer 20 may be 419 or less per 1 mm2 When the number of pores in the cut surface of the intermediate layer 20 is equal to or less than the above upper limit value (1,000 or less), irregular reflection of the light incident on the upper glaze layer 30 caused by the pores in the intermediate layer 20 is easily inhibited. As a result, the irregular reflection of the light at the interface between the upper glaze layer 30 and the intermediate layer 20 is capable of being inhibited so that the “depth” of the sanitary ware 1 is more easily improved. Similarly, when the number of pores in the cut surface of the intermediate layer 20 is equal to or less than the above upper limit value (1,000 or less), irregular reflection of the light incident on the upper glaze layer 30 caused by the pores in the intermediate layer 20 is easily inhibited. As a result, the irregular reflection of the light at the interface between the upper glaze layer 30 and the intermediate layer 20 is capable of being inhibited so that the “beauty” of the sanitary ware 1 is more easily improved. A lower limit value of the number of pores in the cut surface of the intermediate layer 20 is not particularly limited, but is usually 1 or more. The lower limit value of the number of pores in the cut surface of the intermediate layer 20 may be 189 or more per 1 mm2 The lower limit value of the number of pores in the cut surface of the intermediate layer 20 may be 269 or more per 1 mm2 For example, the range of the number of pores in the cut surface of the intermediate layer 20 may be 1 or more and 1,000 or less per 1 mm2 The range of the number of pores in the cut surface of the intermediate layer 20 may be 1 or more and 700 or less per 1 mm2 The range of the number of pores in the cut surface of the intermediate layer 20 may be 1 or more and 500 or less per 1 mm2 The range of the number of pores in the cut surface of the intermediate layer 20 may be 189 or more and 443 or less per 1 mm2 The range of the number of pores in the cut surface of the intermediate layer 20 may be 269 or more and 419 or less per 1 mm2 The number of pores in the cut surface of the intermediate layer 20 can be counted by the same method as the number of pores in the cut surface of the upper glaze layer 30.

The lower limit value of the thickness T20 of the intermediate layer 20 may be 200 μm. The lower limit value of the thickness T20 of the intermediate layer 20 may be 250 μm. The lower limit value of the thickness T20 of the intermediate layer 20 may be 300 μm. The lower limit value of the thickness T20 of the intermediate layer 20 may be 494 μm. The lower limit value of the thickness T20 of the intermediate layer 20 may be 508 μm. The upper limit value of the thickness T20 of the intermediate layer 20 may be 1000 μm. The upper limit value of the thickness T20 of the intermediate layer 20 may be 800 μm. The upper limit value of the thickness T20 of the intermediate layer may be 600 μm. The upper limit value of the thickness T20 of the intermediate layer 20 may be 575 μm. The upper limit value of the thickness T20 of the intermediate layer 20 may be 558 μm. For example, the range of the thickness T20 of the intermediate layer 20 may be 200 μm or more. The range of the thickness T20 of the intermediate layer 20 may be 200 to 1,000 μm. The range of the thickness T20 of the intermediate layer 20 may be 250 to 800 μm. The range of the thickness T20 of the intermediate layer 20 may be 300 to 600 μm. The range of the thickness T20 of the intermediate layer 20 may be 494 to 575 μm. The range of the thickness T20 of the intermediate layer 20 may be 508 to 558 μm. When the thickness T20 is equal to or more than the above lower limit value (200 μm or more), the interface between the intermediate layer 20 and the upper glaze layer 30 is easily flattened. When the thickness T20 is equal to or less than the above upper limit value (1,000 μm or less), the bubbles in the intermediate layer composition are easily discharged outside of the intermediate layer 20.

The thickness T20 of the intermediate layer 20 can be determined, for example, by the following procedure. The sanitary ware 1 is cut along the thickness direction of the intermediate layer 20 using a small sample cutter. The cut surface after cutting is observed with a microscope (DSX510, manufactured by Olympus Corporation) at a magnification of 125 times. In the observed image, a distance between the boundary line between the upper glaze layer 30 and the intermediate layer 20 (upper-intermediate boundary line) and a boundary line between the intermediate layer 20 and the ceramic base material 10 (an intermediate-base material boundary line) is measured at any 20 places. An arithmetic average value of the measured distances is taken as the thickness T20 of the intermediate layer 20.

A difference T20Δ between the maximum value T20MAX of the thickness T20 of the intermediate layer 20 and the minimum value T20MIN of the thickness T20 of the intermediate layer 20 may be 50 μm or less. The difference T20Δ may be 40 μm or less. The difference T20Δ may be 30 μm or less. When the difference T20Δ is equal to or less than the above upper limit value (50 μm or less), irregular reflection of the light at the interface between the upper glaze layer 30 and the intermediate layer 20 is easily inhibited. As a result, the “depth” of the sanitary ware 1 is more easily improved. Similarly, when the difference T20Δ is equal to or less than the above upper limit value (50 μm or less), irregular reflection of the light at the interface between the upper glaze layer 30 and the intermediate layer 20 is easily inhibited. As a result, the “beauty” of the sanitary ware 1 is more easily improved. A lower limit value of the difference T20Δ is not particularly limited, but is usually 0.1 μm or more. For example, the range of the difference T20Δ may be 0.1 μm or more and 50 μm or less. The range of the difference T20Δ may be 0.1 μm or more and 40 μm or less. The range of the difference T20Δ may be 0.1 μm or more and 30 μm or less.

A ratio of the difference T20Δ relative to the thickness T20 (hereinafter also referred to as a “T20Δ/T20 ratio”) may be 25% or less. The T20Δ/T20 ratio may be 20% or less. The T20Δ/T20 ratio may be 10% or less. When the T20Δ/T20 ratio is equal to or less than the upper limit value (25% or less), irregular reflection of the light at the interface between the upper glaze layer 30 and the intermediate layer 20 is easily inhibited. As a result, the “depth” of the sanitary ware 1 is more easily improved. Similarly, when the T20Δ/T20 ratio is equal to or less than the upper limit value (25% or less), irregular reflection of the light at the interface between the upper glaze layer 30 and the intermediate layer 20 is easily inhibited. As a result, the “beauty” of the sanitary ware 1 is more easily improved. A lower limit value of the T20Δ/T20 ratio is not particularly limited, but is usually 0.01% or more. For example, the range of the T20Δ/T20 ratio may be 0.01% or more and 25% or less. The range of the T20Δ/T20 ratio may be 0.01% or more and 20% or less. The range of the T20Δ/T20 ratio may be 0.01% or more and 10% or less.

The maximum value T20MAX of the thickness T20 and the minimum value T20MIN of the thickness T20 can be obtained, for example, by the following procedure. Similarly to the procedure for determining the thickness T20 of the intermediate layer 20, the distance between the upper-intermediate boundary line and the intermediate-base material boundary line is measured at any 20 places. Among the 20 measured places, one place with the largest distance between the upper-intermediate boundary line and the intermediate-base material boundary line is taken as the maximum value T20MAX. Among the 20 measured places, one place with the smallest distance between the upper-intermediate boundary and the intermediate-base material boundary line is taken as the minimum value T20MIN.

[Method of Manufacturing Sanitary Ware]

Next, a method of manufacturing the sanitary ware 1 of the present embodiment will be described. First, a ceramic base material 10 is prepared. The ceramic base material 10 may not be only a molded product obtained by molding the ceramic base material composition, but may also be a molded product obtained by firing and molding the ceramic base material composition. The ceramic base material 10 may be a commercial product which has been molded in advance. The ceramic base material 10 may be a commercial product which has been molded and fired in advance. In the case of firing the ceramic base material composition, the lower limit value of the firing temperature may be 1,100° C. The lower limit value of the firing temperature may be 1,150° C. The upper limit value of the firing temperature may be 1,300° C. The upper limit value of the firing temperature may be 1,250° C. For example, the range of the firing temperature may be 1,100 to 1,300° C. The range of the firing temperature may be 1,150 to 1,250° C. When the firing temperature is equal to or higher than the above lower limit value (1,100° C. or more), the strength of the ceramic base material 10 is easily increased. When the firing temperature is equal to or less than the above upper limit value (1,300° C. or less), deformation of the ceramic base material 10 is easily inhibited.

Next, the intermediate layer composition is applied to the surface of the ceramic base material 10. A method of applying the intermediate layer composition to the surface of the ceramic base material 10 is not particularly limited, and a general method such as dipping, pouring, spraying, or applying can be appropriately selected. From the viewpoint of securing the thickness of the intermediate layer 20, the method of applying the intermediate layer composition to the surface of the ceramic base material 10 may be any of dipping, pouring, applying, and spraying. From the viewpoint of easily making the thickness of the intermediate layer 20 uniform, the spraying is preferable as the method of applying the intermediate layer composition to the surface of the ceramic base material 10. A dip coating method can be exemplified for the dipping. A spray coating method can be exemplified for the spraying.

The amount of the intermediate layer composition applied is not particularly limited, and may be adjusted so that the thickness of the intermediate layer 20 after firing can be 200 μm or more. The amount of the intermediate layer composition applied can be adjusted by appropriately adjusting the content of water in the intermediate layer composition, a viscosity of the intermediate layer composition, the average particle size of the solid content contained in the intermediate layer composition, and the like. By applying the intermediate layer composition to the surface of the ceramic base material 10, a primary coated body is obtained.

By drying the primary coated body, it becomes easy to apply the upper glaze layer composition to the surface of the primary coated body. For this reason, the primary coated body may be dried. The lower limit value of the temperature at the time of drying the primary coated body may be 20° C. The lower limit value of the temperature at the time of drying the primary coated body may be 30° C. The lower limit value of the temperature at the time of drying the primary coated body may be 40° C. The upper limit value of the temperature at the time of drying the primary coated body may be 110° C. The upper limit value of the temperature at the time of drying the primary coated body may be 100° C. The upper limit value of the temperature at the time of drying the primary coated body may be 90° C. For example, the range of the temperature at the time of drying the primary coated body may be 20 to 110° C. The range of the temperature at the time of drying the primary coated body may be 30 to 100° C. The range of the temperature at the time of drying the primary coated body may be 40 to 90° C. When the temperature at the time of drying the primary coated body is equal to or higher than the above lower limit value (20° C. or more), the content of water in the intermediate layer composition is easily reduced. When the temperature at the time of drying the primary coated body is equal to or less than the above upper limit value (110° C. or less), the surface of the intermediate layer 20 is easily flattened. A time for drying the primary coated body may be 0.5 to 48 hours. When the time for drying the primary coated body is equal to or more than the above lower limit value (0.5 hours or more), the intermediate layer composition is easily and sufficiently dried. When the time for drying the primary coated body is equal to or less than the above upper limit value (48 hours or less), productivity of the sanitary ware 1 is easily improved.

Next, the upper glaze layer composition is applied to the surface of the primary coated body. From the viewpoint of making it easy to adjust the thickness of the upper glaze layer 30, the method of applying the upper glaze layer composition may be spraying (also referred to as spray coating).

The amount of the upper glaze layer composition applied is not particularly limited, and may be adjusted so that the thickness of the upper glaze layer 30 after firing can be 100 μm or more. The amount of the upper glaze layer composition applied may be adjusted by appropriately adjusting the content of water in the upper glaze layer composition, the viscosity of the upper glaze layer composition, the average particle size of the solid content contained in the upper glaze layer composition, etc. By applying the upper glaze layer composition to the surface of the primary coated body, a secondary coated body is obtained.

Next, the secondary coated body is fired. As a firing temperature at the time of firing the secondary coated body, a temperature at which the ceramic base material 10 is sintered and the intermediate layer composition and the upper glaze layer composition are softened is preferable. The lower limit value of the firing temperature at the time of firing the secondary coated body may be 1,100° C. The lower limit value of the firing temperature at the time of firing the secondary coated body may be 1,150° C. The upper limit value of the firing temperature at the time of firing the secondary coated body may be 1,300° C. The upper limit value of the firing temperature at the time of firing the secondary coated body may be 1,250° C. For example, the range of the firing temperature at the time of firing the secondary coated body may be 1,100 to 1,300° C. The range of the firing temperature at the time of firing the secondary coated body may be 1,150 to 1,250° C. When the firing temperature at the time of firing the secondary coated body is equal to or higher than the above lower limit value (1,100° C. or more), the upper glaze layer composition is easily and sufficiently melted. In addition, when the firing temperature at the time of firing the second coated body is equal to or higher than the above lower limit value (1,100° C. or more), the intermediate layer composition is easily and sufficiently melted. When the firing temperature at the time of firing the secondary coated body is equal to or less than the above upper limit value (1,300° C. or less), the surface of the upper glaze layer 30 is easily flattened. In addition, when the firing temperature at the time of firing the second coated body is equal to or less than the above upper limit value or less (1,300° C. or less), the interface between the intermediate layer 20 and the upper glaze layer 30 is easily flattened.

The lower limit value of the firing time for firing the secondary coated body may be 1 hour. The lower limit value of the firing time for firing the secondary coated body may be 2 hours. The lower limit value of the firing time for firing the secondary coated body may be 3 hours. The upper limit value of the firing time for firing the secondary coated body may be 168 hours. The upper limit value of the firing time for firing the secondary coated body may be 72 hours. The upper limit value of the firing time for firing the secondary coated body may be 24 hours. For example, the range of the firing time for firing the secondary coated body may be 1 to 168 hours. The range of the firing time for firing the secondary coated body may be 2 to 72 hours. The range of the firing time for firing the secondary coated body may be 3 to 24 hours. When the firing time for firing the secondary coated body is equal to or more than the above lower limit value (1 hour or more), the surface of the upper glaze layer 30 is easily flattened. In addition, when the firing time for firing the second coated body is equal to or more than the above lower limit value (1 hour or more), the interface between the intermediate layer 20 and the upper glaze layer 30 is easily flattened. When the firing time for firing the secondary coated body is equal to or less than the above upper limit value (168 hours or less), productivity of the sanitary ware 1 is easily improved.

A fired product is obtained by firing the second coated body. The fired product is cooled to be the sanitary ware 1. The sanitary ware 1 may be obtained by naturally cooling the fired product, or may be obtained by cooling such as blowing air. The lower limit value of the temperature at the time of cooling the fired product may be 800° C. The lower limit value of the temperature at the time of cooling the fired product may be 900° C. The upper limit value of the temperature at the time of cooling the fired product may be 1,300° C. The upper limit value of the temperature at the time of cooling the fired product may be 1,250° C. For example, the range of the temperature at the time of cooling the fired product may be 800 to 1,300° C. The range of the temperature at the time of cooling the fired product may be 900 to 1,250° C. When the temperature at the time of cooling the fired product is equal to or higher than the above lower limit value (800° C. or more), the bubbles are easily discharged outside of the upper glaze layer 30. When the temperature at the time of cooling the fired product is equal to or less than the above upper limit value (1,300° C. or less), the surface of the upper glaze layer 30 is easily flattened. A cooling rate at the time of cooling the fired product may be 30° C./minute or less. The cooling rate at the time of cooling the fired product may be 10° C./minute or less. The cooling rate at the time of cooling the fired product may be 0.1° C./minute or less. When the cooling rate at the time of cooling the fired product is equal to or less than the above upper limit value (30° C./minute or less), the bubbles are easily discharged outside of the upper glaze layer 30. In addition, when the cooling rate at the time of cooling the fired product is equal to or less than the above upper limit value (30° C./minute or less), the surface of the upper glaze layer 30 is easily flattened.

The sanitary ware 1 may be obtained by applying the intermediate layer composition to the surface of the ceramic base material 10 through dipping, pouring, applying, or spraying, and then firing it to obtain a primary fired body (the first firing step), and applying the upper glaze layer composition to the primary fired body and firing it (the second firing step).

The lower limit value of the firing temperature at the first firing step may be 800° C. The lower limit value of the firing temperature at the first firing step may be 850° C. The upper limit value of the firing temperature at the first firing step may be 1,000° C. The upper limit value of the firing temperature at the first firing step may be 950° C. For example, the range of the firing temperature at the first firing step may be 800 to 1,000° C. The range of the firing temperature at the first firing step may be 850 to 950° C. When the firing temperature at the first firing step is equal to or higher than the above lower limit value (800° C. or more), the intermediate layer composition is easily and sufficiently melted. In addition, when the firing temperature at the first firing step is equal to or higher than the above lower limit value (800° C. or more), degassing of the ceramic base material 10 and the intermediate layer 20 is performed so that the mixing of the pores into the upper glaze layer 30 is easily inhibited. When the firing temperature at the first firing step is equal to or less than the above upper limit value (1,000° C. or less), the surface of the intermediate layer 20 is easily flattened, and the adhesion to the upper glaze layer composition is easily improved. The lower limit value of the firing time at the first firing step may be 1 hour. The lower limit value of the firing time at the first firing may be 2 hours. The lower limit value of the firing time at the first firing step may be 3 hours. The upper limit value of the firing time at the first firing step may be 168 hours. The upper limit value of the firing time at the first firing step may be 72 hours. The upper limit value of the firing time at the first firing step may be 24 hours. For example, the range of the firing time at the first firing step may be 1 to 168 hours. The range of the firing time at the first firing step may be 2 to 72 hours. The range of the firing time at the first firing step may be 3 to 24 hours. When the firing time at the first firing step is equal to or more than the above lower limit value (one hour or more), the surface of the intermediate layer 20 is easily flattened. In addition, when the firing time at the first firing step is equal to or more than the above lower limit value (one hour or more), degassing of the ceramic base material 10 and the intermediate layer 20 is performed so that the mixing of the pores into the upper glaze layer 30 is easily inhibited. When the firing time at the first firing step is equal to or less than the above upper limit value (168 hours or less), productivity of the sanitary ware 1 is easily improved. The primary fired body is obtained by firing the primary coated body.

The primary fired body may be cooled before applying the upper glaze layer composition. The lower limit value of the temperature at the time of cooling the primary fired body may be 800° C. The lower limit value of the temperature at the time of cooling the primary fired body may be 850° C. The upper limit value of the temperature at the time of cooling the primary fired body may be 1,000° C. The upper limit value of the temperature at the time of cooling the primary fired body may be 950° C. For example, the range of the temperature at the time of cooling the primary fired body may be 800 to 1,000° C. The range of the temperature at the time of cooling the primary fired body may be 850 to 950° C. When the temperature at the time of cooling the primary fired body is equal to or higher than the above lower limit value (800° C. or more), the bubbles are easily discharged outside of the intermediate layer 20. When the temperature at the time of cooling the primary fired body is equal to or less than the above upper limit value (1,000° C. or less), the surface of the intermediate layer 20 is easily flattened. A cooling rate at the time of cooling the primary fired body may be 30° C./minute or less. The cooling rate at the time of cooling the primary fired body may be 10° C./minute or less. When the cooling rate at the time of cooling the primary fired body is equal to or less than the above upper limit value (30° C./minute or less), the bubbles are easily discharged outside of the intermediate layer 20. In addition, when the cooling rate at the time of cooling the primary fired body is equal to or less than the above upper limit value (30° C./minute or less), the surface of the intermediate layer 20 is easily flattened.

Next, the upper glaze layer composition is applied to the surface of the primary fired body. From the viewpoint of making it easy to adjust the thickness of the upper glaze layer 30, the method of applying the upper glaze layer composition to the surface of the primary fired body may be spraying (also referred to as spray coating). The amount of the upper glaze layer composition applied to the surface of the primary fired body is the same as the amount of the upper glaze layer composition applied to the surface of the primary coated body. By applying the upper glaze layer composition to the surface of the primary fired body, the secondary coated body is obtained.

Next, the secondary coated body is fired (the second firing step). The lower limit value of the firing temperature at the second firing step may be 1,100° C. The lower limit value of the firing temperature at the second firing step may be 1,150° C. The upper limit value of the firing temperature at the second firing step may be 1,300° C. The upper limit value of the firing temperature at the second firing step may be 1,250° C. For example, the range of the firing temperature at the second firing step may be 1,100 to 1,300° C. The range of the firing temperature at the second firing step may be 1,150 to 1,250° C. When the firing temperature at the second firing step is equal to or higher than the above lower limit value (1,100° C. or more), the upper glaze layer composition is easily and sufficiently melted. When the firing temperature of the second firing step is equal to or less than the above upper limit value (1,300° C. or less), the surface of the upper glaze layer 30 is easily flattened. The lower limit value of the firing time at the second firing step may be 1 hour. The lower limit value of the firing time at the second firing step may be 2 hours. The lower limit value of the firing time at the second firing step may be 3 hours. The upper limit value of the firing time at the second firing step may be 168 hours. The upper limit value of the firing time at the second firing step may be 72 hours. The upper limit value of the firing time at the second firing step may be 24 hours. For example, the range of the firing time at the second firing step may be 1 to 168 hours. The range of the firing time at the second firing step may be 2 to 72 hours. The range of the firing time at the second firing step may be 3 to 24 hours. When the firing time at the second firing step is equal to or more than the above lower limit value (one hour or more), the surface of the upper glaze layer 30 is easily flattened. When the firing time at the second firing step is equal to or less than the above upper limit value (168 hours or less), productivity of the sanitary ware 1 is easily improved. The fired product is obtained through the second firing step. The fired product is cooled to be the sanitary ware 1. The temperature at the time of cooling the fired product is the same as the temperature at the time of cooling the fired product described above. The cooling rate at the time of cooling the fired product is the same as that at the time of cooling the fired product described above.

By obtaining the sanitary ware 1 via the primary fired body, the interface between the intermediate layer 20 and the upper glaze layer 30 is more easily flattened. By obtaining the sanitary ware 1 via the primary fired body, the number of pores contained in the intermediate layer 20 and the upper glaze layer 30 is easily reduced. For this reason, the “depth” of the sanitary ware 1 is more easily improved. Similarly, by obtaining the sanitary ware 1 via the primary fired body, the interface between the intermediate layer 20 and the upper glaze layer 30 is more easily flattened. By obtaining the sanitary ware 1 via the primary fired body, the number of pores contained in the intermediate layer 20 and the upper glaze layer 30 is easily reduced. For this reason, the “beauty” of the sanitary ware 1 is more easily improved. From the viewpoint of more easily improving at least one of the “depth” and the “beauty” of the sanitary ware 1, the method of manufacturing the sanitary ware of the present embodiment preferably obtains the sanitary ware 1 via the primary fired body.

As mentioned above, although the present embodiment has been described in detail with reference to drawings, the present disclosure is not limited to the above embodiment, and can be appropriately modified without departing from the scope of the present disclosure. The components in the above embodiment can appropriately be replaced with well-known components.

In the embodiment described above, the sanitary ware 1 includes the ceramic base material 10, the intermediate layer 20, and the upper glaze layer 30. However, the present disclosure is not limited to the embodiment described above, and, for example, the sanitary ware may not have the intermediate layer. The sanitary ware may have a form in which the upper glaze layer (glaze layer) is provided on the surface of the ceramic base material. The sanitary ware may have another glaze layer between the upper glaze layer 30 and the intermediate layer 20, and the glaze layer may include a plurality of layers. The sanitary ware may be a form in which the intermediate layer, a single layer or multiple layers of the glaze layer, and the upper glaze layer (glaze layer) are provided on the surface of the ceramic base material. From the viewpoint of further improving at least one of the “depth” and the “beauty” of the sanitary ware, the sanitary ware can include the intermediate layer. In the case where the sanitary ware does not have an intermediate layer, the thickness of the upper glaze layer (glaze layer) can be determined, for example, by the following procedure. The sanitary ware is cut along the thickness direction of the upper glaze layer using a small sample cutter. The cut surface after cutting is observed with a microscope (DSX510, manufactured by Olympus Corporation) at a magnification of 125 times. In the observed image, the distance between a boundary line between the upper glaze layer and the ceramic base material (an upper-base material boundary line) and the surface of the upper glaze layer is measured at any 20 places. An arithmetic average value of the measured distances is taken as the thickness of the upper glaze layer.

### EXAMPLES

Next, the present disclosure will be described in more detail by way of examples, but the present disclosure is not limited thereto. Raw materials used in these examples are as shown in the following [Used raw material].

[Used Raw Material]

<Ceramic Base Raw Material>

A-1: 10 parts by mass of china stone, 40 parts by mass of feldspar, 50 parts by mass of clay (70 mass % of SiO2, 25 mass % of Al2O3, and 5 mass % in total of Na2O, K2O, CaO, MgO and ZnO).

A-2: 30 parts by mass of china stone, 70 parts by mass of clay (65 mass % of SiO2, 30 mass % of Al2O3, and 5 mass % in total of Na2O, K2O, CaO, MgO and ZnO).

<Intermediate Layer Raw Material>

B-1: 65 mass % of SiO2, 20 mass % of Al2O3, 12 mass % in total of Na2O, K2O, CaO, MgO and ZnO, and 3 mass % of the others.

B-2: A mixture of the ceramic base raw material A-2 and the following glaze raw material C-9 at a mass ratio (ceramic base/glaze ratio) of 80/20.

B-3: A mixture of the ceramic base raw material A-2 and the following glaze raw material C-9 at a mass ratio (ceramic base/glaze ratio) of 70/30.

B-4: A mixture of the ceramic base raw material A-2 and the following glaze raw material C-9 at a mass ratio (ceramic base/glaze ratio) of 60/40.

B-5: A mixture of the ceramic base raw material A-2 and the following glaze raw material C-9 at a mass ratio (ceramic base/glaze ratio) of 50/50.

B-6: A mixture of the ceramic base raw material A-2 and the following glaze raw material C-9 at a mass ratio (ceramic base/glaze ratio) of 40/60.

B-7: A mixture of the ceramic base raw material A-2 and the following glaze raw material C-9 at a mass ratio (ceramic base/glaze ratio) of 30/70.

B-8: A mixture of the ceramic base raw material A-2 and the following glaze raw material C-9 at a mass ratio (ceramic base/glaze ratio) of 20/80.

B-9: A mixture of the ceramic base raw material A-2 and the following glaze raw material C-9 at a mass ratio (ceramic base/glaze ratio) of 10/90.

B-10: A mixture of the ceramic base raw material A-2 and the following glaze raw material C-9 at a mass ratio (ceramic base/glaze ratio) of 0/100.

<Glaze Raw Material>

C-1: 63 mass % of SiO2, 12 mass % of Al2O3, 24 mass % in total of Na2O, K2O, CaO, MgO, ZnO, SrO, BaO and B2O3, and 1 mass % of the others.

C-2: 62 mass % of SiO2, 13 mass % of Al2O3, 24 mass % in total of Na2O, K2O, CaO, MgO, ZnO, SrO, BaO and B2O3, and 1 mass % of the others.

C-3: 62 mass % of SiO2, 13 mass % of Al2O3, 24 mass % in total of Na2O, K2O, CaO, MgO, ZnO, SrO, BaO and B2O3, and 1 mass % of the others.

C-4: 64 mass % of SiO2, 12 mass % of Al2O3, and 24 mass % in total of Na2O, K2O, CaO, MgO, ZnO, SrO, BaO and B2O3.

C-5: 57 mass % of SiO2, 10 mass % of Al2O3, 32 mass % in total of Na2O, K2O, CaO, MgO, ZnO, SrO, BaO and B2O3, and 1 mass % of the others.

C-6: 63 mass % of SiO2, 12 mass % of Al2O3, 24 mass % in total of Na2O, K2O, CaO, MgO, ZnO, SrO, BaO and B2O3, and 1 mass % of the others.

C-7: 66 mass % of SiO2, 12 mass % of Al2O3, and 22 mass % in total of Na2O, K2O, CaO, MgO, ZnO, SrO, BaO and B2O3.

C-8: 70 mass % of SiO2, 11 mass % of Al2O3, and 19 mass % in total of Na2O, K2O, CaO, MgO, ZnO, SrO, BaO and B2O3.

C-9: 63 mass % of SiO2, 10 mass % of Al2O3, 20 mass % in total of Na2O, K2O, CaO, MgO, ZnO, SrO, BaO and B2O3, and 7 mass % of the others.

C-10: 61 mass % of SiO2, 12 mass % of Al2O3, and 27 mass % in total of Na2O, K2O, CaO, MgO, ZnO, SrO, BaO and B2O3.

C-11: 57 mass % of SiO2, 11 mass % of Al2O3, 25 mass % in total of Na2O, K2O, CaO, MgO, ZnO, SrO, BaO and B2O3, and 7 mass % of the others.

[Preparation of Ceramic Base Material]

1 kg of the ceramic base raw material A-1 and 0.4 kg of water were mixed to obtain a mixture. The mixture was ground by a ball mill for 20 hours to obtain a ceramic base material composition. As a result of measuring the particle size of the solid content of the ceramic base material composition using a laser diffraction type particle size distribution-measuring device (“MT3300EX (model number),” manufactured by Nikkiso Co., Ltd.), D50 was 12 μm.

Next, the ceramic base material composition was poured into a plaster mold having a length of 100 mm, a width of 100 mm, and a thickness of 10 mm to obtain a ceramic base material.

[Preparation of Frit]

The glaze raw materials C-1 to C-11 were melted at 1,500° C. as frit raw materials to obtain the frits F-1 to F-11.

[Preparation of Intermediate Layer Composition]

1 kg of the intermediate layer raw material B-1 and 0.4 kg of water were mixed to obtain a mixture. The mixture was ground by a ball mill for 20 hours to obtain the intermediate layer composition M-1. As a result of measuring the particle size of the solid content of the intermediate layer composition M-1 using the laser diffraction type particle size distribution-measuring device, D50 was 8 μm.

The intermediate layer compositions M-2 to M-10 were obtained in the same method as the intermediate layer composition M-1 except that the intermediate layer raw materials B-2 to B-10 were used instead of the intermediate layer raw material B-1. The intermediate layer composition M-11 was prepared by mixing 1 kg of the glaze raw material C-11 and 0.6 kg of water as an intermediate layer raw material to obtain a mixture. In Tables 1 and 2, the “Type” of the intermediate layer composition represents any of the intermediate layer compositions M-1 to M-11. The “D50 (μm)” of the intermediate layer composition represents the 50% average particle size (D50) of any of the above intermediate layer compositions M-1 to M-11.

[Preparation of Upper Glaze Layer Composition]

1 kg of the frit F-1 and 0.6 kg of water were mixed to obtain a mixture. The mixture was ground by a ball mill for 30 hours, and a viscosity modifier such as carboxymethyl cellulose was added to adjust viscosity, whereby the upper glaze layer composition G-1 was obtained. As a result of measuring the particle size of the solid content of the upper glaze layer composition G-1 using the above-mentioned laser diffraction type particle size distribution-measuring device, D50 was 15 μm.

The upper glaze layer compositions G-2 to G-10 were obtained by the same method as the upper glaze layer composition G-1 except that the frits F-2 to F-10 were used instead of the frit F-1. In Tables 1 and 2, the “Type” of the upper glaze layer composition represents any of the above-mentioned upper glaze layer compositions G-1 to G-10. The “D50 (μm)” of the upper glaze layer composition represents the 50% average particle size (D50) of any of the above upper glaze layer compositions G-1 to G-10.

### Examples 1 to 18 and Comparative Examples 1 to 2

[Preparation of Sanitary Ware]

The intermediate layer compositions described in Tables 1 and 2 were applied to the above-mentioned ceramic base material using a spray coating method, dried at 60° C. for 1 hour, and then spray coated with the upper glaze layer compositions described in Tables 1 and 2, whereby secondary coated bodies were obtained. The secondary coated bodies were fired at 1,220° C. for 20 hours to obtain rectangular solid samples of the sanitary ware.

<Measurement of Thickness of Upper Glaze Layer>

A sample of each example was cut using a small sample cutter along the thickness direction along a plane which passes through a midpoint of one side of the sample in a longitudinal direction thereof and is parallel to a width direction of the sample. The cut surface after cutting was observed with a microscope (DSX510, manufactured by Olympus Corporation) at a magnification of 125 times. The observed image from one end to the other end in the width direction was divided into 10 parts in the width direction, and the distance from the surface of the upper glaze layer to the upper-intermediate boundary line (L30) was measured at 2 places for each sample. Distances (L30) in total of 20 places were measured for one sample, and the maximum value and the minimum value of the thickness of the upper glaze layer, the difference between the maximum value and the minimum value, and the average value were determined. An average value of the distances (L30) was determined as the thickness of the upper glaze layer. The results are shown in Tables 1 and 2. In the tables, the term “Difference” represents the difference between the maximum value and the minimum value of the thickness of the upper glaze layer.

<Measurement of Thickness of Intermediate Layer>

Using the image observed in the thickness of the upper glaze layer, the observed image from one end to the other end in the width direction was divided into 10 parts in the width direction, and the distance between the upper-intermediate boundary line and the intermediate-base material boundary line (L20) was measured at 2 places for each sample. Distances (L20) in total of 20 places were measured for one sample, and the average value was determined as the thickness of the intermediate layer. The results are shown in Tables 1 and 2.

<Measurement of First Melting Temperature>

The intermediate layer composition used in each example was dried at 80° C. for 2 hours to obtain a sample powder of each example. A DTA measurement was performed such that, using a DTA device (TG8121, manufactured by RIGAKU CO., LTD.), 30 mg of alumina powder (reference substance) and 30 mg of the sample powder of each example were heated at a heating rate of 3° C./minute while flowing air at normal temperature (25° C.) at a flow rate of 200 mL/minute. In the obtained DTA curve, the first inflection point at which the potential difference ΔV that appears in the region where the temperature of the reference substance exceeds 700° C. decreases was obtained, and the temperature of the reference substance at the first inflection point was taken as the first melting temperature. The potential difference ΔV corresponds to a value ΔT obtained by subtracting the temperature of the reference substance from the temperature of the sample powder. The measured first melting temperatures are shown in Table 1.

<Measurement of Second Melting Temperature>

In the above DTA curve, the first inflection point (second inflection point) which appears on a higher temperature side than the first melting temperature and at which the potential difference ΔV increases was obtained, and the temperature of the reference substance at the second inflection point was taken as the second melting temperature. The potential difference ΔV corresponds to a value ΔT obtained by subtracting the temperature of the reference substance from the temperature of the sample powder. The measured second melting temperatures are shown in Table 1.

<Measurement of Average Pore Size, Pore Area Ratio, Number of Pores>

Using the image observed with the above microscope, the image was binarized with device processing software (WinROOF2015, provided by Mitani Shoji Co., Ltd.). The average pore size, the pore area ratio, and the number of pores in the cut surface of the upper glaze layer were determined by performing image analysis of the binarized image. In addition, the average pore size, the pore area ratio, and the number of pores in the cut surface of the intermediate layer were determined. The results are shown in Tables 1 and 2.

<Measurement of Image Clarity>

A sample of each example was prepared, and the DOI value was measured by a Wave-Scan DOI measuring device (Wave-Scan-DUAL, manufactured by BYK Gardner). The results are shown in Tables 1 and 2.

<Evaluation of “Depth”>

A sample of each example was prepared, held up to a fluorescent light in a room, and subjected to appearance sensitivity evaluation from the viewpoint of feeling the deepness of light as the “depth” and feeling of the surface cleanness. The appearance sensitivity evaluation was conducted by 10 subjects, and the “depth” was evaluated based on the following evaluation criteria. The results are shown in Tables 1 and 2.

<<Evaluation Criteria>>

GOOD: The number of subjects who feel the “depth” is 5 or more.

NG: The number of subjects who feel the “depth” is 4 or less.

<Evaluation of “Underlayer Blur”>

A sample of each example was prepared, held up to a fluorescent light in a room, and subjected to appearance sensitivity evaluation from the viewpoint of feeling an “underlayer blur” of sanitary ware. Here, the term “underlayer blur” refers to a blur in a layer (intermediate layer) under the upper glaze layer, which can be seen through the upper glaze layer on the surface of the sanitary ware. It is judged by human vision whether the underlayer is blurred or not. Sanitary ware with little “underlayer blur” has excellent “beauty.” The appearance sensitivity evaluation was conducted by 10 subjects, and the “underlayer blur” was evaluated based on the following evaluation criteria. The results are shown in Tables 1 and 2.

<<Evaluation Criteria>>

GOOD: The number of subjects who do not feel “underlayer blur” is 7 or more.

OK: The number of subjects who do not feel “underlayer blur” is 5 or more.

NG: The number of subjects who do not feel “underlayer blur” is 4 or less.

TABLE 1

| | | | | Example Number | | | | | |
|---|---|---|---|---|---|---|---|---|---|
| | | | | E1 | E2 | E3 | E4 | E5 | E6 |
| Structure of | Upper Glaze | Upper Glaze | Type | G-1 | G-2 | G-3 | G-4 | G-5 | G-6 |
| Layers | Layer | Layer | D50 (μm) | 15 | 15 | 15 | 15 | 15 | 15 |
| | | Composition | | | | | | | |
| | | Thickness | Maximum | 295 | 275 | 325 | 278 | 360 | 303 |
| | | (μm) | Value | | | | | | |
| | | | Minimum | 265 | 227 | 278 | 240 | 333 | 286 |
| | | | Value | | | | | | |
| | | | Difference | 30 | 48 | 47 | 38 | 28 | 17 |
| | | | Average | 282 | 253 | 309 | 269 | 349 | 295 |
| | | | Value | | | | | | |
| | | Average Pore Size (μm) | | 13 | 14 | 14 | 23 | 24 | 17 |
| | | Pore Area Ratio (%) | | 0.43 | 0.95 | 1.53 | 1.32 | 1.38 | 1.26 |
| | | Number of Pores (/mm²) | | 26 | 41 | 48 | 27 | 16 | 40 |
| | Intermediate | Intermediate | Type | M-1 | M-1 | M-1 | M-1 | M-1 | M-1 |
| | Layer | Layer | Ceramic | — | — | — | — | — | — |
| | | Composition | base/glaze | | | | | | |
| | | | ratio | | | | | | |
| | | | First Melting | — | — | — | — | — | — |
| | | | Temperature | | | | | | |
| | | | (° C.) | | | | | | |
| | | | Second | — | — | — | — | — | — |
| | | | Melting | | | | | | |
| | | | Temperature | | | | | | |
| | | | (° C.) | | | | | | |
| | | | D50 (μm) | 8 | 8 | 8 | 8 | 8 | 8 |
| | | Thickness | Average | 512 | 558 | 583 | 508 | 554 | 555 |
| | | (μm) | Value | | | | | | |

| | | | | | | |
|---|---|---|---|---|---|---|
| Average Pore Size (μm) | 14 | 14 | 13 | 13 | 14 | 13 |
| Pore Area Ratio (%) | 10.65 | 10.48 | 8.69 | 9.10 | 8.74 | 9.75 |
| Number of Pores (/mm²) | 440 | 419 | 398 | 443 | 349 | 415 |

| | | | | | | | |
|---|---|---|---|---|---|---|---|
| Evaluation | Depth | GOOD | GOOD | GOOD | GOOD | GOOD | GOOD |
| | Underlayer Blur | — | — | — | — | — | — |
| | Image Clarity | 92 | 91 | 91 | 94 | 93 | 94 |

| | | | | Example Number | | | | |
|---|---|---|---|---|---|---|---|---|
| | | | | E7 | E8 | E9 | E10 | E11 |
| Structure of | Upper Glaze | Upper Glaze | Type | G-7 | G-8 | G-9 | G-4 | G-4 |
| Layers | Layer | Layer | D50 (μm) | 15 | 15 | 15 | 15 | 15 |
| | | Composition | | | | | | |
| | | Thickness | Maximum | 328 | 324 | 327 | 225 | 252 |
| | | (μm) | Value | | | | | |
| | | | Minimum | 299 | 296 | 299 | 170 | 232 |
| | | | Value | | | | | |
| | | | Difference | 29 | 28 | 28 | 55 | 19 |
| | | | Average | 319 | 318 | 311 | 206 | 243 |
| | | | Value | | | | | |

| | Average Pore Size (μm) | | 15 | 13 | 12 | 15 | 20 |
|---|---|---|---|---|---|---|---|
| | Pore Area Ratio (%) | | 1.31 | 1.34 | 1.32 | 2.30 | 2.11 |
| | Number of Pores (/mm²) | | 51 | 59 | 69 | 70 | 47 |
| Intermediate | Intermediate | Type | M-1 | M-1 | M-1 | M-2 | M-3 |
| Layer | Layer | Ceramic | — | — | — | 80/20 | 70/30 |
| | Composition | base/glaze | | | | | |
| | | ratio | | | | | |
| | | First Melting | — | — | — | 951 | 925 |
| | | Temperature | | | | | |
| | | (° C.) | | | | | |
| | | Second | — | — | — | 1,235 | 1,220 |
| | | Melting | | | | | |
| | | Temperature | | | | | |
| | | (° C.) | | | | | |
| | | D50 (μm) | 8 | 8 | 8 | 9 | 9 |
| | Thickness | Average | 497 | 511 | 523 | 488 | 504 |
| | (μm) | Value | | | | | |

| | | | | | |
|---|---|---|---|---|---|
| Average Pore Size (μm) | 14 | 13 | 14 | 8 | 12 |
| Pore Area Ratio (%) | 9.18 | 9.34 | 9.74 | 7.56 | 9.46 |
| Number of Pores (/mm²) | 417 | 432 | 398 | 613 | 535 |

| | | | | | | |
|---|---|---|---|---|---|---|
| Evaluation | Depth | GOOD | GOOD | GOOD | GOOD | GOOD |
| | Underlayer Blur | — | — | — | NG | GOOD |
| | Image Clarity | 85 | 85 | 77 | 80 | 85 |

TABLE 2

| | | | | Example Number | | | | | | | | |
|---|---|---|---|---|---|---|---|---|---|---|---|---|
| | | | | E12 | E13 | E14 | E15 | E16 | E17 | E18 | CE1 | CE2 |
| Structure | Upper | Upper Glaze | Type | G-4 | G-4 | G-4 | G-4 | G-4 | G-4 | G-4 | G-10 | G-10 |
| of Layers | Glaze | Layer | D50 (μm) | 15 | 15 | 15 | 15 | 15 | 15 | 15 | 15 | 15 |
| | Layer | Composition | | | | | | | | | | |
| | | Thickness | Maximum | 253 | 231 | 199 | 221 | 244 | 265 | 245 | 604 | 1085 |
| | | (μm) | Value | | | | | | | | | |
| | | | Minimum | 227 | 197 | 159 | 172 | 165 | 187 | 186 | 528 | 0 |
| | | | Value | | | | | | | | | |
| | | | Difference | 26 | 34 | 40 | 48 | 79 | 77 | 59 | 76 | 1085 |
| | | | Average | 242 | 221 | 181 | 214 | 218 | 222 | 225 | 572 | 862 |
| | | | Value | | | | | | | | | |
| | | Average Pore Size (μm) | | 9 | 16 | 19 | 12 | 17 | 14 | 8 | 68 | 60 |
| | | Pore Area Ratio (%) | | 0.70 | 2.82 | 1.15 | 2.31 | 1.41 | 0.71 | 0.71 | 3.29 | 3.50 |
| | | Number of Pores (/mm²) | | 67 | 103 | 30 | 93 | 40 | 35 | 74 | 3 | 10 |
| | Inter- | Intermediate | Type | M-4 | M-5 | M-6 | M-7 | M-8 | M-9 | M-10 | M-1 | M-11 |
| | mediate | Layer | Ceramic | 60/40 | 50/50 | 40/60 | 30/70 | 20/80 | — | — | — | — |
| | Layer | Composition | base/glaze | | | | | | | | | |
| | | | ratio | | | | | | | | | |
| | | | First | 938 | 946 | 912 | 864 | 859 | — | — | — | — |
| | | | Melting | | | | | | | | | |
| | | | Temperature | | | | | | | | | |
| | | | (° C.) | | | | | | | | | |
| | | | Second | 1,213 | 1,214 | 1,133 | 1,088 | 1,027 | — | — | — | — |
| | | | Melting | | | | | | | | | |
| | | | Temperature | | | | | | | | | |
| | | | (° C.) | | | | | | | | | |
| | | | D50 (μm) | 8 | 8 | 8 | 7 | 7 | 6 | 6 | 8 | 15 |
| | | Thickness | Average | 575 | 596 | 494 | 505 | 566 | 551 | 456 | 576 | 782 |
| | | (μm) | Value | | | | | | | | | |

| | | | | | | | | | |
|---|---|---|---|---|---|---|---|---|---|
| Average Pore Size (μm) | 13 | 16 | 19 | 27 | 20 | 28 | 25 | 14 | 70 |
| Pore Area Ratio (%) | 10.91 | 11.23 | 9.76 | 14.36 | 12.09 | 11.36 | 6.70 | 7.99 | 6.00 |
| Number of Pores (/mm²) | 430 | 269 | 189 | 135 | 149 | 100 | 65 | 298 | 20 |

| | | | | | | | | | | |
|---|---|---|---|---|---|---|---|---|---|---|
| Evaluation | Depth | GOOD | GOOD | GOOD | GOOD | GOOD | GOOD | GOOD | NG | NG |
| | Underlayer Blur | GOOD | GOOD | GOOD | OK | NG | — | — | — | — |
| | Image Clarity | 93 | 89 | 87 | 82 | 80 | 91 | 91 | 70 | 70 |

As shown in Tables 1 and 2, in Examples 1 to 18, the evaluation of the “depth” was “GOOD,” and it was found that the “depth” had been further improved. In addition, in Examples 11 to 15, in which the difference between the maximum value and the minimum value of the thickness of the upper glaze layer is equal to or less than 50 μm, the evaluation of “underlayer blur” is “GOOD” or “OK”, and it was found that the “beauty” had been further improved. On the other hand, in Comparative Examples 1 (CE1) and 2 (CE2) in which the average pore size in the cut surface of the upper glaze layer is out of the applicable range of the present disclosure, the evaluation of the “depth” was “NG”.

According to the sanitary ware of the present disclosure, it was found that the “depth” of sanitary ware can be further improved. According to the sanitary ware of the present disclosure, it was found that the “beauty” of sanitary ware can be further improved.

1. A sanitary ware, comprising:
a ceramic base material;
an upper glaze layer positioned on a surface of the ceramic base material; and
an intermediate layer positioned between the ceramic base material and the upper glaze layer,
wherein a ratio of an area of pores to an area of a cut surface obtained by cutting the upper glaze layer along a thickness direction thereof is equal to or less than 3%.

2. A sanitary ware, comprising:
a ceramic base material;
an upper glaze layer positioned on a surface of the ceramic base material; and
an intermediate layer positioned between the ceramic base material and the upper glaze layer,
wherein an average pore size of pores in a cut surface obtained by cutting the upper glaze layer along a thickness direction thereof is equal to or less than 50 μm.

3. The sanitary ware of claim 2, wherein the number of pores in the cut surface is equal to or less than 120 per 1 mm².

4. The sanitary ware of claim 1,
wherein an average pore size of pores in the cut surface is equal to or less than 50 μm, and
the number of pores in the cut surface is equal to or less than 120 per 1 mm².

5. The sanitary ware of claim 1,
wherein the number of pores in a cut surface obtained by cutting the intermediate layer along a thickness direction thereof is equal to or less than 1,000 per 1 mm²,
a ratio of an area of pores to an area of the cut surface of the intermediate layer is equal to or less than 20%, and
the average pore size of pores in the cut surface of the intermediate layer is equal to or less than 25 μm.

6. The sanitary ware of claim 1, wherein a thickness of the upper glaze layer is equal to or more than 100 μm.

7. The sanitary ware of claim 1, wherein a thickness of the intermediate layer is equal to or more than 200 μm.

8. A method of manufacturing the sanitary ware of claim 1, comprising:
applying an intermediate layer composition for forming the intermediate layer to a surface of the ceramic base material either by dipping, pouring, applying, or spraying, and then drying; and
applying an upper glaze layer composition for forming the upper glaze layer to the surface of the ceramic base material on which the intermediate layer composition has been applied.

9. A method of manufacturing the sanitary ware of claim 1, comprising:
applying an intermediate layer composition for forming the intermediate layer to a surface of the ceramic base material either by dipping, pouring, applying, or spraying, and then firing to obtain a primary fired body; and
applying an upper glaze layer composition for forming the upper glaze layer to the primary fired body, and firing.

10. The sanitary ware of claim 2,
wherein the number of pores in a cut surface obtained by cutting the intermediate layer along a thickness direction thereof is equal to or less than 1,000 per 1 mm²,
a ratio of an area of pores to an area of the cut surface of the intermediate layer is equal to or less than 20%, and
the average pore size of pores in the cut surface of the intermediate layer is equal to or less than 25 μm.

11. The sanitary ware of claim 2, wherein a thickness of the upper glaze layer is equal to or more than 100 μm.

12. The sanitary ware of claim 2, wherein a thickness of the intermediate layer is equal to or more than 200 μm.

13. A method of manufacturing the sanitary ware of claim 2, comprising:
applying an intermediate layer composition for forming the intermediate layer to a surface of the ceramic base material either by dipping, pouring, applying, or spraying, and then drying; and
applying an upper glaze layer composition for forming the upper glaze layer to the surface of the ceramic base material on which the intermediate layer composition has been applied.

14. A method of manufacturing the sanitary ware of claim 2, comprising:
applying an intermediate layer composition for forming the intermediate layer to a surface of the ceramic base material either by dipping, pouring, applying, or spraying, and then firing to obtain a primary fired body; and
applying an upper glaze layer composition for forming the upper glaze layer to the primary fired body, and firing.

15. A sanitary ware, comprising:
a ceramic base material;
an upper glaze layer positioned on a surface of the ceramic base material; and
an intermediate layer positioned between the ceramic base material and the upper glaze layer,
wherein a difference between a maximum value of a thickness of the upper glaze layer and a minimum value of a thickness of the upper glaze layer is equal to or less than 50 μm.

16. The sanitary ware of claim 15, wherein an average pore size of pores in a cut surface obtained by cutting the intermediate layer along a thickness direction thereof is equal to or less than 25 μm.

17. The sanitary ware of claim 15, wherein a ratio of an area of pores to an area of a cut surface obtained by cutting the intermediate layer along a thickness direction thereof is equal to or less than 20%.

18. A method of manufacturing the sanitary ware of claim 15, comprising:
applying an intermediate layer composition for forming the intermediate layer to a surface of the ceramic base material either by dipping, pouring, applying, or spraying, and then drying; and
applying an upper glaze layer composition for forming the upper glaze layer to the surface of the ceramic base material on which the intermediate layer composition has been applied.

19. A method of manufacturing the sanitary ware of claim 15, comprising:
applying an intermediate layer composition for forming the intermediate layer to a surface of the ceramic base material either by dipping, pouring, applying, or spraying, and then firing to obtain a primary fired body; and
applying an upper glaze layer composition for forming the upper glaze layer to the primary fired body, and firing.

20. The sanitary ware of claim 15, wherein a ratio of an area of pores to an area of a cut surface obtained by cutting the upper glaze layer along a thickness direction thereof is equal to or less than 3%.
